(19) United States
(12) Patent Application Publication
(10) Pub. No.: US 2024/0389157 A1
(43) Pub. Date: Nov. 21, 2024

(54) PREAMBLE TRANSMISSION ON RANDOM-ACCESS CHANNEL OCCASION OVERLAPPING WITH DOWNLINK SYMBOLS

(71) Applicant: Nokia Technologies Oy, Espoo (FI)

(72) Inventors: Nhat-Quang NHAN, Massy (FR); Cassio Barboza RIBEIRO, Espoo (FI); Alessio MARCONE, Munich (DE); Elena PERALTA CALVO, Tampere (FI); Axel MUELLER, Massy (FR); Marco MASO, Massy (FR)

(21) Appl. No.: 18/686,092

(22) PCT Filed: Sep. 3, 2021
(86) PCT No.: PCT/EP2021/074406

§ 371 Date: Feb. 23, 2024

(51) Int. Cl. H04W 74/0833; H04L 5/14

(52) U.S. Cl. CPC H04W 74/0833; H04L 5/14

(57) ABSTRACT

Disclosed is a method comprising transmitting, to a network element of a wireless communication network, if cross-division duplexing is supported by the network element, a random-access preamble on at least one random-access channel occasion that overlaps with one or more downlink symbols in time.

### FIELD

The following exemplary embodiments relate to wireless communication.

### BACKGROUND

As resources are limited, it is desirable to optimize the usage of network resources. A cell and/or a terminal device in a cellular communication network may be utilized to enable better usage of resources and enhanced user experience to a user of the terminal device.

### SUMMARY

The scope of protection sought for various exemplary embodiments is set out by the independent claims. The exemplary embodiments and features, if any, described in this specification that do not fall under the scope of the independent claims are to be interpreted as examples useful for understanding various exemplary embodiments.

According to an aspect, there is provided an apparatus comprising at least one processor, and at least one memory including computer program code, wherein the at least one memory and the computer program code are configured, with the at least one processor, to cause the apparatus to: transmit, to a network element of a wireless communication network, if cross-division duplexing is supported by the network element, a random-access preamble on at least one random-access channel occasion that overlaps with one or more downlink symbols in time.

According to another aspect, there is provided an apparatus comprising means for: transmitting, to a network element of a wireless communication network, if cross-division duplexing is supported by the network element, a random-access preamble on at least one random-access channel occasion that overlaps with one or more downlink symbols in time.

According to another aspect, there is provided a method comprising: transmitting, to a network element of a wireless communication network, if cross-division duplexing is supported by the network element, a random-access preamble on at least one random-access channel occasion that overlaps with one or more downlink symbols in time.

According to another aspect, there is provided a computer program comprising instructions for causing an apparatus to perform at least the following: transmitting, to a network element of a wireless communication network, if cross-division duplexing is supported by the network element, a random-access preamble on at least one random-access channel occasion that overlaps with one or more downlink symbols in time.

According to another aspect, there is provided a computer program product comprising program instructions which, when run on a computing apparatus, cause the computing apparatus to perform at least the following: transmitting, to a network element of a wireless communication network, if cross-division duplexing is supported by the network element, a random-access preamble on at least one random-access channel occasion that overlaps with one or more downlink symbols in time.

According to another aspect, there is provided a computer readable medium comprising program instructions for causing an apparatus to perform at least the following: transmitting, to a network element of a wireless communication network, if cross-division duplexing is supported by the network element, a random-access preamble on at least one random-access channel occasion that overlaps with one or more downlink symbols in time.

According to another aspect, there is provided a non-transitory computer readable medium comprising program instructions for causing an apparatus to perform at least the following: transmitting, to a network element of a wireless communication network, if cross-division duplexing is supported by the network element, a random-access preamble on at least one random-access channel occasion that overlaps with one or more downlink symbols in time.

According to another aspect, there is provided an apparatus comprising at least one processor, and at least one memory including computer program code, wherein the at least one memory and the computer program code are configured, with the at least one processor, to cause the apparatus to: receive, from a terminal device, a random-access preamble on at least one random-access channel occasion that overlaps with one or more downlink symbols; and transmit, to the terminal device, in response to receiving the random-access preamble, a message indicative of a configuration for transmitting a radio resource control setup request message at least in one or more downlink slots operated in a cross-division duplexing mode supporting cross-division duplexing.

According to another aspect, there is provided an apparatus comprising: means for receiving, from a terminal device, a random-access preamble on at least one random-access channel occasion that overlaps with one or more downlink symbols; and means for transmitting, to the terminal device, in response to receiving the random-access preamble, a message indicative of a configuration for transmitting a radio resource control setup request message at least in one or more downlink slots operated in a cross-division duplexing mode.

According to another aspect, there is provided a method comprising: receiving, from a terminal device, a random-access preamble on at least one random-access channel occasion that overlaps with one or more downlink symbols; and transmitting, to the terminal device, in response to receiving the random-access preamble, a message indicative of a configuration for transmitting a radio resource control setup request message at least in one or more downlink slots operated in a cross-division duplexing mode supporting cross-division duplexing.

According to another aspect, there is provided a computer program comprising instructions for causing an apparatus to perform at least the following: receiving, from a terminal device, a random-access preamble on at least one random-access channel occasion that overlaps with one or more downlink symbols; and transmitting, to the terminal device, in response to receiving the random-access preamble, a message indicative of a configuration for transmitting a radio resource control setup request message at least in one or more downlink slots operated in a cross-division duplexing mode supporting cross-division duplexing.

According to another aspect, there is provided a computer program product comprising program instructions which, when run on a computing apparatus, cause the computing apparatus to perform at least the following: receiving, from a terminal device, a random-access preamble on at least one random-access channel occasion that overlaps with one or more downlink symbols; and transmitting, to the terminal device, in response to receiving the random-access preamble, a message indicative of a configuration for transmitting a radio resource control setup request message at least in one or more downlink slots operated in a cross-division duplexing mode supporting cross-division duplexing.

According to another aspect, there is provided a computer readable medium comprising program instructions for causing an apparatus to perform at least the following: receiving, from a terminal device, a random-access preamble on at least one random-access channel occasion that overlaps with one or more downlink symbols; and transmitting, to the terminal device, in response to receiving the random-access preamble, a message indicative of a configuration for transmitting a radio resource control setup request message at least in one or more downlink slots operated in a cross-division duplexing mode supporting cross-division duplexing.

According to another aspect, there is provided a non-transitory computer readable medium comprising program instructions for causing an apparatus to perform at least the following: receiving, from a terminal device, a random-access preamble on at least one random-access channel occasion that overlaps with one or more downlink symbols; and transmitting, to the terminal device, in response to receiving the random-access preamble, a message indicative of a configuration for transmitting a radio resource control setup request message at least in one or more downlink slots operated in a cross-division duplexing mode supporting cross-division duplexing.

According to another aspect, there is provided a system comprising at least a terminal device and a network element of a wireless communication network. The terminal device is configured to: transmit, to the network element, if cross-division duplexing is supported by the network element, a random-access preamble on at least one random-access channel occasion that overlaps with one or more downlink symbols in time. The network element is configured to: receive, from the terminal device, the random-access preamble; and transmit, to the terminal device, in response to receiving the random-access preamble, a message indicative of a configuration for transmitting a radio resource control setup request message at least in one or more downlink slots operated in a cross-division duplexing mode supporting cross-division duplexing.

According to another aspect, there is provided a system comprising at least a terminal device and a network element of a wireless communication network. The terminal device comprises means for: transmitting, to the network element, if cross-division duplexing is supported by the network element, a random-access preamble on at least one random-access channel occasion that overlaps with one or more downlink symbols in time. The network element comprises means for: receiving, from the terminal device, the random-access preamble; and transmit, to the terminal device, in response to receiving the random-access preamble, a message indicative of a configuration for transmitting a radio resource control setup request message at least in one or more downlink slots operated in a cross-division duplexing mode supporting cross-division duplexing.

### BRIEF DESCRIPTION OF THE DRAWINGS

In the following, various exemplary embodiments will be described in greater detail with reference to the accompanying drawings, in which

FIG. 1 illustrates an exemplary embodiment of a cellular communication network;

FIG. 2 illustrates the concept of cross-division duplexing;

FIG. 3 illustrates an example of a time-division duplexing pattern;

FIG. 4 illustrates a 4-step random-access procedure;

FIG. 5 illustrates an example of time-domain resource determination for random-access channel occasions;

FIG. 6 illustrates an example of valid random-access occasions according to 30 a legacy rule;

FIG. 7 illustrates two approaches for device type separation;

FIG. 8 illustrates an example of random-access channel occasions supported by a base station capable of cross-division duplexing according to an exemplary embodiment;

FIG. 9-10 illustrate signaling diagrams according to some exemplary embodiments;

FIGS. 11-12 illustrate flow charts according to some exemplary embodiments;

FIGS. 13-18 illustrate examples of mapping synchronization signal block beams to random-access channel occasions according to some exemplary embodiments;

FIGS. 19-22 illustrate flow charts according to some exemplary embodiments;

FIGS. 23-24 illustrate apparatuses according to some exemplary embodiments.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

In the following, different exemplary embodiments will be described using, as an example of an access architecture to which the exemplary embodiments may be applied, a radio access architecture based on long term evolution advanced (LTE Advanced, LTE-A) or new radio (NR, 5G), without restricting the exemplary embodiments to such an architecture, however. It is obvious for a person skilled in the art that the exemplary embodiments may also be applied to other kinds of communications networks having suitable means by adjusting parameters and procedures appropriately. Some examples of other options for suitable systems may be the universal mobile telecommunications system (UMTS) radio access network (UTRAN or E-UTRAN), long term evolution (LTE, substantially the same as E-UTRA), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

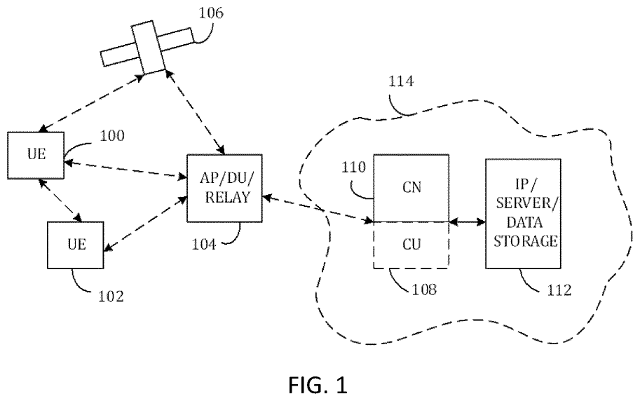

FIG. 1 depicts examples of simplified system architectures showing some elements and functional entities, all being logical units, whose implementation may differ from what is shown. The connections shown in FIG. 1 are logical connections; the actual physical connections may be different. It is apparent to a person skilled in the art that the system may also comprise other functions and structures than those shown in FIG. 1.

The exemplary embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a cell with an access node (such as (e/g)NodeB) 104 providing the cell. The physical link from a user device to a (e/g)NodeB may be called uplink or reverse link and the physical link from the (e/g)NodeB to the user device may be called downlink or forward link. It should be appreciated that (e/g)NodeBs or their functionalities may be implemented by using any node, host, server or access point etc. entity suitable for such a usage.

A communication system may comprise more than one (e/g)NodeB, in which case the (e/g)NodeBs may also be configured to communicate with one another over links, wired or wireless, designed for the purpose. These links may be used for signaling purposes. The (e/g)NodeB may be a computing device configured to control the radio resources of communication system it is coupled to. The (e/g)NodeB may also be referred to as a base station, an access point or any other type of interfacing device including a relay station capable of operating in a wireless environment. The (e/g)NodeB may include or be coupled to transceivers. From the transceivers of the (e/g)NodeB, a connection may be provided to an antenna unit that establishes bi-directional radio links to user devices. The antenna unit may comprise a plurality of antennas or antenna elements. The (e/g)NodeB may further be connected to core network 110 (CN or next generation core NGC). Depending on the system, the counterpart on the CN side may be a serving gateway (S-GW, routing and forwarding user data packets), packet data network gateway (P-GW), for providing connectivity of user devices (UEs) to external packet data networks, or mobile management entity (MME), etc.

The user device (also called UE, user equipment, user terminal, terminal device, etc.) illustrates one type of an apparatus to which resources on the air interface may be allocated and assigned, and thus any feature described herein with a user device may be implemented with a corresponding apparatus, such as a relay node. An example of such a relay node may be a layer 3 relay (self-backhauling relay) towards the base station. The self-backhauling relay node may also be called an integrated access and backhaul (IAB) node. The IAB node may comprise two logical parts: a mobile termination (MT) part, which takes care of the backhaul link(s) (i.e., link(s) between IAB node and a donor node, also known as a parent node) and a distributed unit (DU) part, which takes care of the access link(s), i.e., child link(s) between the IAB node and UE(s) and/or between the IAB node and other IAB nodes (multi-hop scenario).

The user device may refer to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example may be a camera or video camera loading images or video clips to a network. A user device may also be a device having capability to operate in Internet of Things (IoT) network which is a scenario in which objects may be provided with the ability to transfer data over a network without requiring human-to-human or human-to-computer interaction. The user device may also utilize cloud. In some applications, a user device may comprise a small portable device with radio parts (such as a watch, earphones or eyeglasses) and the computation may be carried out in the cloud. The user device (or in some exemplary embodiments a layer 3 relay node) may be configured to perform one or more of user equipment functionalities. The user device may also be called a subscriber unit, mobile station, remote terminal, access terminal, user terminal, terminal device, or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts interconnected ICT devices (sensors, actuators, processors of microcontrollers, etc.) embedded in physical objects at different locations. Mobile cyber physical systems, in which the physical system in question may have inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications may support a wide range of use cases and related applications including video streaming, augmented reality, different ways of data sharing and various forms of machine type applications (such as (massive) machine-type communications (mMTC), including vehicular safety, different sensors and real-time control. 5G may be expected to have multiple radio interfaces, namely below 6 GHz, cmWave and mmWave, and also being integrable with existing legacy radio access technologies, such as the LTE. Integration with the LTE may be implemented, at least in the early phase, as a system, where macro coverage may be provided by the LTE, and 5G radio interface access may come from small cells by aggregation to the LTE. In other words, 5G may support both inter-RAT operability (such as LTE-5G) and inter-RI operability (inter-radio interface operability, such as below 6 GHz-cmWave, below 6 GHz-cmWave-mmWave). One of the concepts considered to be used in 5G networks may be network slicing in which multiple independent and dedicated virtual sub-networks (network instances) may be created within the substantially same infrastructure to run services that have different requirements on latency, reliability, throughput and mobility.

The current architecture in LTE networks may be fully distributed in the radio and fully centralized in the core network. The low latency applications and services in 5G may need to bring the content close to the radio which leads to local break out and multi-access edge computing (MEC). 5G may enable analytics and knowledge generation to occur at the source of the data. This approach may need leveraging resources that may not be continuously connected to a network such as laptops, smartphones, tablets and sensors. MEC may provide a distributed computing environment for application and service hosting. It may also have the ability to store and process content in close proximity to cellular subscribers for faster response time. Edge computing may cover a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system may also be able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head (RRH) or a radio unit (RU), or a base station comprising radio parts. It may also be possible that node operations will be distributed among a plurality of servers, nodes or hosts. Carrying out the RAN real-time functions at the RAN side (in a distributed unit, DU 104) and non-real time functions in a centralized manner (in a central unit, CU 108) may be enabled for example by application of cloudRAN architecture.

It should also be understood that the distribution of labour between core network operations and base station operations may differ from that of the LTE or even be non-existent. Some other technology advancements that may be used may be Big Data and all-IP, which may change the way networks are being constructed and managed. 5G (or new radio, NR) networks may be designed to support multiple hierarchies, where MEC servers may be placed between the core and the base station or nodeB (gNB). It should be appreciated that MEC may be applied in 4G networks as well.

5G may also utilize satellite communication to enhance or complement the coverage of 5G service, for example by providing backhauling. Possible use cases may be providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano) satellites are deployed). At least one satellite 106 in the mega-constellation may cover several satellite-enabled network entities that create on-ground cells. The on-ground cells may be created through an on-ground relay node 104 or by a gNB located on-ground or in a satellite.

It is obvious for a person skilled in the art that the depicted system is only an example of a part of a radio access system and in practice, the system may comprise a plurality of (e/g)NodeBs, the user device may have an access to a plurality of radio cells and the system may also comprise other apparatuses, such as physical layer relay nodes or other network elements, etc. At least one of the (e/g)NodeBs or may be a Home (e/g) nodeB.

Furthermore, the (e/g) nodeB or base station may also be split into: a radio unit (RU) comprising a radio transceiver (TRX), i.e., a transmitter (TX) and a receiver (RX); one or more distributed units (DUs) that may be used for the so-called Layer 1 (L1) processing and real-time Layer 2 (L2) processing; and a central unit (CU) or a centralized unit that may be used for non-real-time L2 and Layer 3 (L3) processing. The CU may be connected to the one or more DUs for example by using an F1 interface. Such a split may enable the centralization of CUs relative to the cell sites and DUs, whereas DUs may be more distributed and may even remain at cell sites. The CU and DU together may also be referred to as baseband or a baseband unit (BBU). The CU and DU may also be comprised in a radio access point (RAP).

The CU may be defined as a logical node hosting higher layer protocols, such as radio resource control (RRC), service data adaptation protocol (SDAP) and/or packet data convergence protocol (PDCP), of the (e/g) nodeB or base station. The DU may be defined as a logical node hosting radio link control (RLC), medium access control (MAC) and/or physical (PHY) layers of the (e/g) nodeB or base station. The operation of the DU may be at least partly controlled by the CU. The CU may comprise a control plane (CU-CP), which may be defined as a logical node hosting the RRC and the control plane part of the PDCP protocol of the CU for the (e/g) nodeB or base station. The CU may further comprise a user plane (CU-UP), which may be defined as a logical node hosting the user plane part of the PDCP protocol and the SDAP protocol of the CU for the (e/g) nodeB or base station.

Cloud computing platforms may also be used to run the CU and/or DU. The CU may run in a cloud computing platform, which may be referred to as a virtualized CU (vCU). In addition to the vCU, there may also be a virtualized DU (vDU) running in a cloud computing platform. Furthermore, there may also be a combination, where the DU may use so-called bare metal solutions, for example application-specific integrated circuit (ASIC) or customer-specific standard product (CSSP) system-on-a-chip (SoC) solutions. It should also be understood that the distribution of labour between the above-mentioned base station units, or different core network operations and base station operations, may differ.

Additionally, in a geographical area of a radio communication system, a plurality of different kinds of radio cells as well as a plurality of radio cells may be provided. Radio cells may be macro cells (or umbrella cells) which may be large cells having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. In multilayer networks, one access node may provide one kind of a cell or cells, and thus a plurality of (e/g)NodeBs may be needed to provide such a network structure.

For fulfilling the need for improving the deployment and performance of communication systems, the concept of “plug-and-play” (e/g)NodeBs may be introduced. A network which may be able to use “plug-and-play” (e/g)NodeBs, may include, in addition to Home (e/g)NodeBs (H (e/g) nodeBs), a home node B gateway, or HNB-GW (not shown in FIG. 1). A HNB Gateway (HNB-GW), which may be installed within an operator's network, may aggregate traffic from a large number of HNBs back to a core network.

Cross-division duplexing (xDD) is a duplexing scheme that enables simultaneous use of downlink (DL) and uplink (UL) radio resources within a time-division duplexing (TDD) carrier, using non-overlapping frequency-domain resources. Herein radio resources may refer to time-domain resources and/or frequency-domain resources. In xDD, duplexing may be implemented in the time domain or in the frequency domain or in both domains within a single TDD carrier. Different from frequency-division duplexing (FDD) or full-duplex, in xDD different UEs may be configured with different UE-specific TDD patterns. Hence, the simultaneous use of DL and UL radio resources occurs exclusively at the base station. In other words, in xDD, the base station is able to transmit and receive at the same time, but UEs may not be able to transmit and receive at the same time, since the UEs may apply TDD. The UE just needs to be aware that the base station supports xDD operation in order to interpret the corresponding signaling, for example suitable TDD pattern(s), provided by the base station. Thus, TDD UEs may be supported by an xDD base station without any modification or changes needed at the UE side. xDD may be supported in NR Rel-18 and/or beyond.

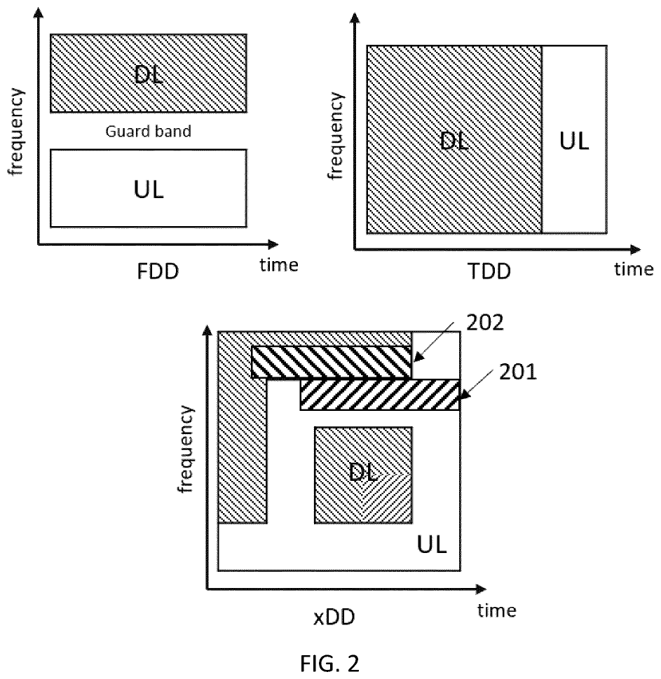

FIG. 2 illustrates the concept of xDD in comparison to FDD and TDD. In xDD, a base station may schedule non-overlapping frequency resources to different UEs, as shown in FIG. 2. For example, a first UE 201 (e.g., a cell-edge UE) may be assigned to transmit continuously on UL radio resources, while the base station transmits DL transmissions to serve a second UE 202 at the same time. In case the first and the second UE are operated in TDD mode, the first and the second UE may be configured with the same or different TDD patterns. In other words, the base station may transmit a DL transmission to the second UE and receive an UL transmission from the first UE simultaneously. A given UE may transmit or receive according to the UE-specific TDD pattern configured by the base station. The TDD pattern at the first UE may be different than the TDD pattern at the second UE, and the base station is aware of the difference between the two TDD patterns.

In 5G NR carriers and bands operating in TDD mode, a pre-defined TDD pattern may be broadcast by the base station to inform the TDD UE in which slots UL and DL symbols are to be expected (or used). The TDD pattern may be encoded in system information block type 1 (SIB1), i.e. ServingCellConfigCommonSIB, as follows:

TDD-UL-DL-ConfigCommon ::= SEQUENCE {

| | |
|---|---|
| referenceSubcarrierSpacing | SubcarrierSpacing, |
| pattern1 | TDD-UL-DL-Pattern, |
| pattern2 | TDD-UL-DL-Pattern |

OPTIONAL,
...
}
TDD-UL-DL-Pattern ::= SEQUENCE {

| | |
|---|---|
| dl-UL-TransmissionPeriodicity | ENUMERATED {ms0p5, |

ms0p625, ms1,

ms1p25, ms2,

ms2p5, ms5, ms10},

| | |
|---|---|
| nrofDownlinkSlots | INTEGER |

(0..maxNrofSlots),

| | |
|---|---|
| nrofDownlinkSymbols | INTEGER |

(0..maxNrofSymbols-1),

| | |
|---|---|
| nrofUplinkSlots | INTEGER |

(0..maxNrofSlots),

| | |
|---|---|
| nrofUplinkSymbols | INTEGER |

```
(0..maxNrofSymbols-1),
  ...,
  [[
    dl-UL-TransmissionPeriodicity-v1530 ENUMERATED {ms3, ms4}
OPTIONAL -- Need R
  ]]
      }
```

There are three slot configurations: downlink (D), uplink (U), and flexible (F). Flexible is used, if a slot contains symbols for both UL and DL. For example, flexible slots may provide downlink data symbols in the beginning, a DL/UL switching gap, and a few UL symbols for quick hybrid automatic repeat request (HARQ) feedback. It is noted that pre-xDD slot patterns may enforce the D/U/F mode for each symbol for the whole spectrum covered by the carrier.

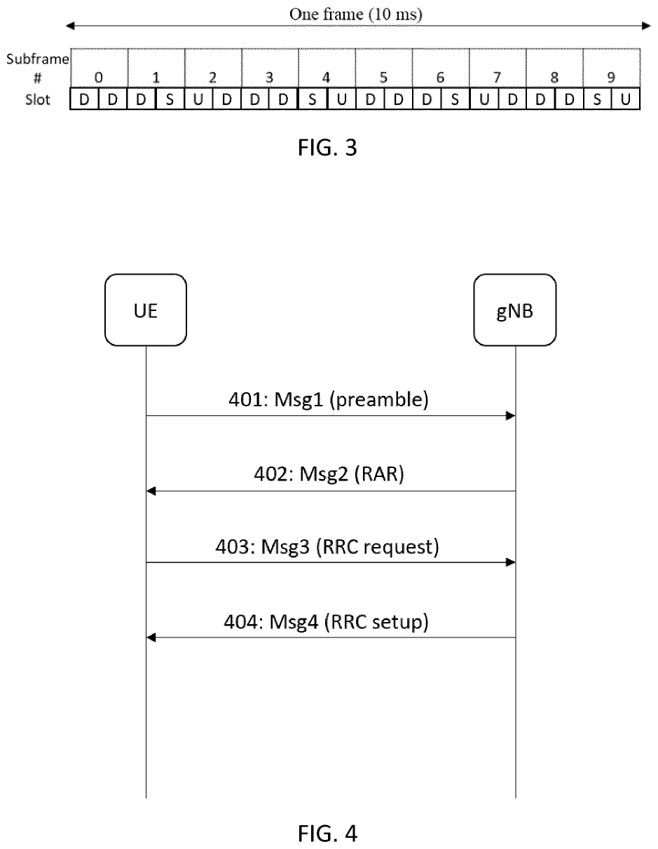

One example of a TDD pattern is 3D1S1U, i.e., 3 downlink slots, 1 switching gap, and 1 uplink slot. FIG. 3 illustrates an example of TDD pattern 3D1S1U with 30 kHz subcarrier spacing.

A UE may perform a random-access procedure to access a network. The purpose of performing the random-access procedure may be, for example, initial access, handover, scheduling request, or timing synchronization. There are currently two types of random-access procedures: a contention-based random-access procedure (CBRA) and a contention-free random-access procedure (CFRA). CFRA may also be referred to as non-contention based random access. In CFRA, a given UE has a dedicated (i.e., UE-specific) random-access preamble allocated by the base station, whereas in CBRA the UE selects the preamble randomly from a pool of preambles shared with other UEs in the cell. In CBRA, the contention (or collision) may occur, if two or more UEs attempt the random-access procedure by using the same random-access procedure on the same resource.

5G NR supports two different CBRA procedures: 4-step RACH (in Rel-15) and 2-step RACH (in Rel-16). RACH is an acronym for random-access channel.

FIG. 4 illustrates a 4-step RACH procedure. The 4-step RACH starts with a UE transmitting 401 a random-access preamble, which may also be referred to as message 1 (Msg1), to a base station such as a gNB via the physical random-access channel (PRACH) using a specific radio resource called a RACH occasion.

The base station replies 402 to the UE with a random-access response (RAR) message, which may also be referred to as message 2 (Msg2). The RAR message comprises the detected preamble identifier, a timing advance command, a temporary cell radio network temporary identifier (TC-RNTI), and an UL grant for the transmission of message 3 (Msg3) on the physical uplink shared channel (PUSCH). In other words, in Msg2, the base station schedules the resource for the UE to transmit Msg3 over PUSCH.

The UE responds to Msg2 over the scheduled PUSCH by transmitting 403 Msg3 to the base station. Msg3 may also be referred to as RRC request, and it may comprise an identifier for contention resolution.

The base station responds to Msg3 by transmitting 404, to the UE, the contention resolution message, i.e., message 4 (Msg4), comprising the contention-resolution identifier. Msg4 may also be referred to as RRC setup. Upon reception of Msg4, the UE transmits an acknowledgement (ACK) on a physical uplink control channel (PUCCH), if its contention-resolution identifier is carried by Msg4. This completes the 4-step RACH.

Prior to Msg1, there may also be a preliminary step of sending and receiving a synchronization signal block (SSB), i.e., DL beam sweeping, which is not formally part of the RACH procedure. As a result of this preliminary step, the UE may select the index of the preferred SSB beam and decode the associated physical broadcast channel (PBCH) for the master information block (MIB), the system information block (SIB), and so on. This index may also be used by the UE to identify a suitable RACH occasion for the preamble transmission (i.e., Msg1), according to the SSB-to-RACH-occasion mapping indicated by SIB1.

SSB is a reference signal that may be used for beam management. To enable a UE to find a cell while entering a system, as well as to find new cells when moving within the system, a synchronization signal comprising a primary synchronization signal (PSS) and a secondary synchronization signal (SSS) may be periodically transmitted on the downlink from a given cell. Thus, the PSS and SSS along with PBCH may be jointly referred to as the SSB. The synchronization is a process, in which the UE obtains the time and frequency information of the wireless network in order for the UE to access the network.

The 2-step RACH is otherwise similar to the 4-step RACH described above, but Msg1 and Msg3 are combined into a single message (denoted as MsgA) and transmitted by the UE without waiting for feedback (e.g., Msg2) in between. Similarly, the base station combines Msg2 and Msg4 into a single message denoted as MsgB.

Within a random-access procedure, the preamble transmission may take place in network-configured random-access channel occasions, which may also be referred to as RACH occasions or PRACH transmission occasions. Several consecutive RACH occasions in the time and frequency domains may be configured within one PRACH slot. If N is the number of RACH occasions in time within a slot, and F is the number of frequency-multiplexed occasions, then one PRACH slot covers F*N RACH occasions. The network may configure a time-periodic pattern of PRACH slots. The total number of RACH occasions within a PRACH configuration period is then F*N*S, where S denotes the number of PRACH slots per configuration period.

The time-domain resource for RACH occasions may be RRC configured with a PRACH configuration index (prach-ConfigurationIndex in RACH-ConfigGeneric), which acts as an indicator to a row of a pre-defined table. The table may be defined in the 3^{rd} generation partnership project (3GPP) specifications, for example. With the parameters indicated by the PRACH configuration index, the UE may determine the preamble format for PRACH and find the RACH occasions in the time domain.

An example of time-domain resource determination for RACH occasions for PRACH configuration index 251 is provided in the following. It should be noted that other configuration indices also exist.

Table 1 below shows the row of the pre-defined table corresponding with PRACH configuration index 251. The second column in Table 1 provides information on the preamble format defined for this configuration index. In this example, preamble format C2 should be used. The third column in Table 1 defines the system frame numbers (SFNs) with RACH occasions. In this example, RACH occasions are allocated at the system frame numbers (n_{SFN}) that satisfy n_{SFN} mod 1=0. The fourth column in Table 1 defines the reference slots, or subframes, within a radio frame with RACH occasions. In this example, within a given SFN, RACH occasions are allocated at subframes #2 and #7. The fifth column in Table 1 defines the starting symbol parameter for calculation of the RACH transmission symbols. The sixth column in Table 1 defines the number of PRACH slots within a subframe. The seventh column in Table 1 defines the number (Nₜ^{RA,slot}) of PRACH occasions within a PRACH slot. The last column in Table 1 defines the duration (N_{dur}^{RA}) of a given RACH occasion expressed as a number of orthogonal frequency-division multiplexing (OFDM) symbols. In this example, the duration of a given RACH occasion is 6 OFDM symbols (although the actual duration of the preamble format may be less than that).

Using the information on the start symbol and the number of occasions within a PRACH slot, it is possible to determine the start symbol for RACH occasions within the PRACH slot. In this example, within a given subframe, the RACH occasions start at symbols #0, #6, #14, and #20, i.e., l=l₀+14Nₛₗₒₜ^{RA}+nₜ^{RA}N_{dur}^{RA}=0+14×{0,1}+{0,1}×6={0,6,14,20}. The symbol number may be continuously counted regardless of the number of slots within the subframe, which depends on the subcarrier spacing configured for PRACH.

TABLE 1

| | | | | | | Number of | | |
|---|---|---|---|---|---|---|---|---|
| PRACH | | | | | | PRACH slots | | |
| configuration | Preamble | n_{SFN} mod x= | | Subframe | Starting | within a | | |
| index | format | x | y | number | symbol | subframe | Nₜ^{RA, slot} | N_{dur}^{RA} |
| 251 | C2 | 1 | 0 | 2, 7 | 0 | 2 | 2 | 6 |

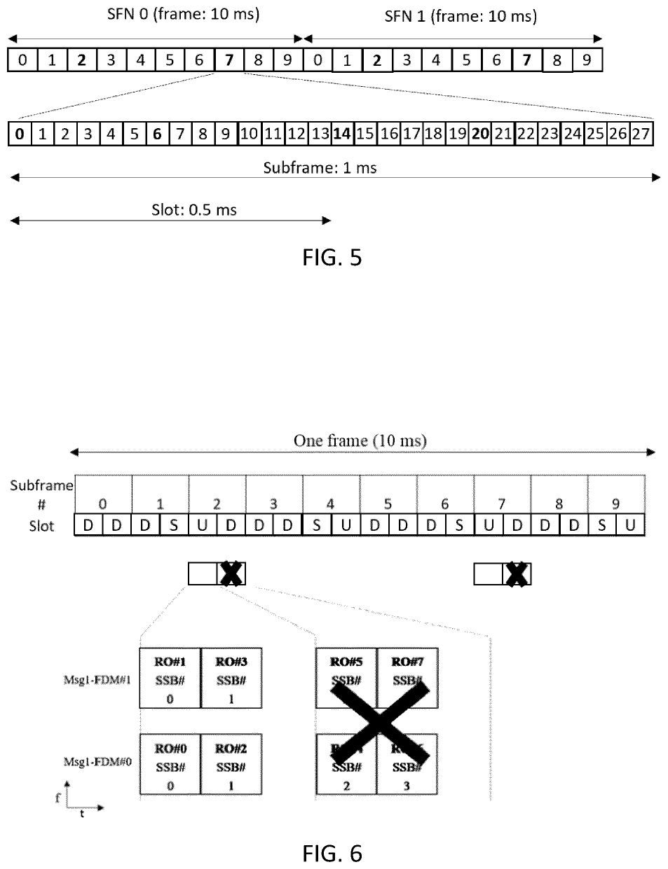

FIG. 5 illustrates the above example of time-domain resource determination for RACH occasions for PRACH configuration index 251. In this example, the UE is allowed to transmit PRACH preambles at subframes #2 and #7, and the RACH occasions start at symbols #0, #6, #14, and #20 within a given subframe. In this example, the radio frame periodicity is 10 ms, the length of one subframe is 1 ms (e.g., 28 symbols/2 slots when a subcarrier spacing is 30 kHz), and the length of one slot is 0.5 ms. The PRACH preamble may be smaller than the subframe in the time domain.

Finally, the validity of the determined RACH occasions may be checked. According to the legacy rule of NR Rel-15 and Rel-16, a RACH occasion may be determined as valid, if it is within UL symbols or if it has a sufficient gap after the last SSB/DL symbol in case it is within flexible symbols.

The parameters msg1-FrequencyStart and msg1-FDM configured in RACH-ConfigGeneric indicate the offset of the lowest RACH occasion in the frequency domain (i.e., to give the position in the frequency domain) and the number of RACH occasions multiplexed in the frequency domain within a given set of OFDM symbols, respectively. The number of occupied resource blocks (RBs) per RACH occasion may be expressed in number of RBs for PUSCH, depending on the configured subcarrier spacings for PRACH and PUSCH.

The parameter ssb-perRACH-OccasionAndCB-PreamblesPerSSB configured in RACH-ConfigCommon indicates two pieces of information: 1) the number of SSBs per RACH occasion, and 2) the number of contention-based preambles per SSB. RACH occasions may be arranged in increasing order of frequency resource indices, time resource indices of the RACH occasions within a PRACH slot, and the PRACH slots, sequentially.

FIG. 6 illustrates an example of valid RACH occasions (RO) in one frame determined according to the legacy rule of Rel-15 and Rel-16. This example corresponds with the above example for PRACH configuration index 251. This example further assumes the following additional configuration: a 3D1S1U TDD pattern, Msg1-FDM=two, and SSBs per RACH occasion is one-half. Msg1-FDM indicates a number of RACH occasions that are frequency-division multiplexed (FDMed) in one time instance (i.e., the number of RACH occasions is two in this example). There may be multiple RACH occasions within one slot and they may have different positions in the frequency domain. In FIG. 6, f denotes frequency and t denotes time. A given RACH occasion may be associated with one SSB beam used to communicate with the base station. It can be observed in this example that, although the PRACH configuration index 251 indicates the RACH occasions in the second slots of the subframes #2 and #7, those RACH occasions are not considered as valid due to overlap with DL symbols. In this case, subframe #2 has RACH occasions #0 and #1 mapped to SSB beam #0, RACH occasions #2 and #3 mapped to SSB beam #1, RACH occasions #4 and #5 mapped to SSB beam #2, and RACH occasions #6 and #7 mapped to SSB beam #3. However, RACH occasions #4, #5, #6, and #7 fall within a DL slot, and thus they are considered as invalid according to the legacy rule (as indicated by the cross in FIG. 6), and therefore they cannot be used. SSB beams #2 and #3 may be mapped to valid RACH occasions in subframe #7.

A problem with PRACH is the fragmentation of the PRACH resources in terms of RACH occasions and/or preambles used for different UE types. In other words, the limited effective preamble resources are continuously being diminished by NR evolution.

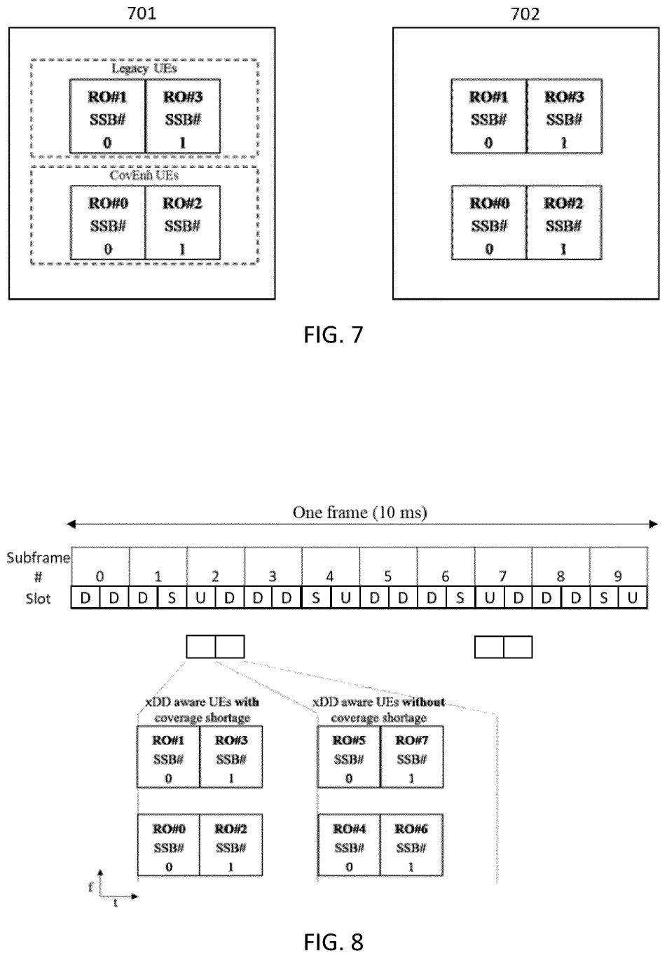

Different RACH occasions or preambles may be used to implicitly differentiate, for example, between coverage enhancement (CovEnh) UEs vs. legacy UEs, and/or between reduced capability (RedCap) UEs vs non-RedCap UEs. The two main approaches for the differentiation are: 1) UE type separation using different RACH occasions, and 2) UE type separation using the same RACH occasions but different preambles. These two approaches are illustrated in FIG. 7, wherein block 701 illustrates UE type separation using different RACH occasions, and block 702 illustrates UE type separation using the same RACH occasions but different preambles. In other words, different types of UEs may be separated into different type-specific resource pools. In block 701, a first subset of RACH occasions (i.e., RACH occasion #1 and RACH occasion #3) are used for legacy UEs, whereas a second subset of RACH occasions (i.e., RACH occasions #0 and RACH occasion #2) are used for CovEnh UEs. Thus, the different subsets of RACH occasions may be used to separate these two different types of UEs. It should be noted that other approaches are also possible (e.g., a combination of the two approaches). For example, implementation of resource separation using RACH occasion masks (e.g., “ra-ssb-OccasionMaskIndex”) or frequency offsets (e.g., “msg1-FrequencyStart”) for multiplexing of CovEnh and legacy RACH occasions with otherwise equal configurations may also be possible.

Regardless of which approach is used for UE type separation, and regardless of which UE types are considered, as long as the resources of PRACH are fragmented, there is a strong impact on legacy UEs. Indeed, the base station does not know beforehand how many UEs in the cell will be using a given resource pool. This forces the base station to reserve a conservative number of RACH occasions and/or preambles for both UE types, in order to ensure that the collision does not become too large. This blind configuration may lead to the following three issues: 1) collisions increase unpredictably, 2) RACH latency increases due to the larger number of collisions, and 3) scheduling procedure complexity increases at the base station due to the collisions.

Some exemplary embodiments may be used to exploit the structure of xDD in order to increase the number of valid RACH occasions by enabling the use of RACH occasions that overlap with DL symbols, and thus mitigate the above issues related to collisions caused by the fragmentation of PRACH resources. Some exemplary embodiments may be applied, for example, to Msg1 in 4-step RACH or to the preamble/Msg1 part of MsgA in 2-step RACH.

As mentioned previously, different TDD patterns may be indicated to different UEs, when the base station is capable of xDD operations. The TDD pattern indicated to a given UE may be based on UE-specific demands, such as UL/DL traffic, coverage, etc. This UE-specific TDD pattern is helpful in RRC connected mode. However, in initial access or RRC re-connection, using different TDD patterns for different UEs may not be beneficial, at least before Msg1 is detected. Therefore, one TDD pattern may be used for all UEs in the cell, when sending Msg1, even if the base station supports xDD operations. As mentioned previously, according to the legacy rule of NR Rel-15 and Rel-16, the RACH occasions need to be within UL symbols to be considered valid. However, a base station that supports xDD operations is able to transmit and receive at the same time, and thus such an xDD-capable base station can also use RACH occasions that overlap with DL slots.

Based on the above observations, more resources for PRACH would be available, if RACH occasions that overlap with DL symbols were labeled as valid RACH occasions, when the base station supports xDD. This may reduce the issues related to collisions, as shown in FIG. 8.

In some exemplary embodiments, RACH occasions that overlap with DL symbols may be considered as valid and supported by xDD-capable base stations, as well as by UEs that are aware of the xDD capability of the base station and able to use these RACH occasions that overlap with DL symbols. Such UEs may be referred to as xDD-aware UEs herein.

FIG. 8 illustrates an example of additional RACH occasions supported by an xDD-capable base station and used by xDD-aware UEs according to an exemplary embodiment. In FIG. 8, one or more RACH occasions overlapping with DL symbols are considered as valid. For example, in FIG. 8, subframe #2 has RACH occasions #0 and #1 mapped to SSB beam #0, RACH occasions #2 and #3 mapped to SSB beam #1, RACH occasions #4 and #5 mapped to SSB beam #0, and RACH occasions #6 and #7 mapped to SSB beam #1. RACH occasions #0, #1, #2, and #3 are within an UL slot, and RACH occasions #4, #5, #6, and #7 are within a DL slot. A UE with coverage shortage may use SSB beam #0 or #1 in the UL slot, whereas a UE without coverage shortage may use SSB beam #0 or #1 in the DL slot (i.e., at a different time than the UE with coverage shortage using the UL slot). In this case, RACH occasions #4, #5, #6 and #7 in the DL slot are considered as valid assuming xDD-capable base station and used by xDD-aware UEs. Otherwise, according to the legacy rule, RACH occasions #4, #5, #6 and #7 would not be considered as valid.

Additionally, some exemplary embodiments may provide a new SSB-to-RACH-occasion mapping that may be used by the xDD-aware UEs. This new mapping may be used for valid RACH occasions overlapping with DL symbols, whereas the legacy mapping may be used only for valid RACH occasions occurring on UL slots (e.g., according to Rel-15 or Rel-16 behavior). For example, in the new SSB-to-RACH-occasion mapping, the mapping in the preceding UL slot may be replicated for the DL slot operated in xDD. However, other mapping approaches may also be used.

When the base station configures access over the cell, a cell-specific signaling may be provided via SIB1, and this cell-specific signaling informs the UE(s) in the cell about how the PRACH configuration and associated configuration periods are configured. Such periods may comprise groups of RACH occasions. Once the UE is able to locate the RACH occasions, the information that the base station provides via SIB1 also provides information on how to handle the mapping of RACH occasions to SSB beams, such that no ambiguity exists either at the base station or at the UE on which RACH occasion is associated with which SSB beam. The base station needs to know which receive filter to use for which RACH occasion, since a given SSB beam is associated with a specific antenna panel configuration at the base station in reception and transmission. For example, if the UE transmits the PRACH preamble over a RACH occasion mapped with SSB beam #1, and the base station uses the panel configuration associated with SSB beam #4 instead, then the base station may not receive anything.

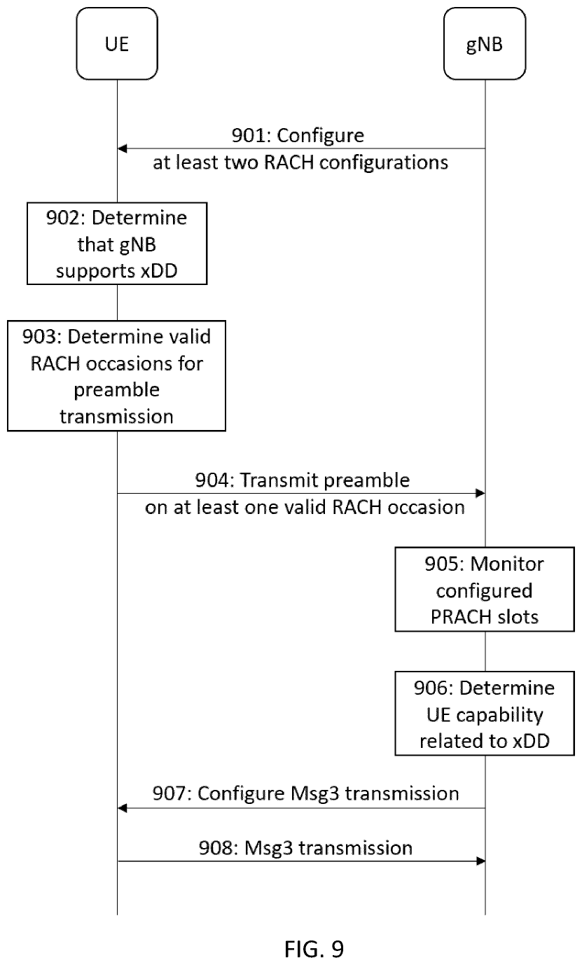

FIG. 9 illustrates a signaling diagram according to an exemplary embodiment, wherein a base station implicitly indicates that it supports xDD. Referring to FIG. 9, an xDD-capable base station (for example a gNB supporting xDD) configures 901 at least two different RACH configurations (e.g., two RACH-ConfigGeneric parameters) for a plurality of UEs (for example all UEs in the cell). For example, the two different RACH configurations may comprise a first RACH configuration referred to as a primary RACH configuration, and a second RACH configuration referred to as a secondary RACH configuration. These two RACH configurations may comprise different sets of RACH occasions.

One of the two RACH configurations, for example the secondary RACH configuration, may be used exclusively by a group or subset of UEs, for example by xDD-aware UEs, in the cell to determine the resources for RACH occasions on UL and/or DL symbols, since RACH occasions overlapped with DL symbols are also considered as valid by xDD-aware UEs. In other words, non-XDD-aware UEs may not be able to use the secondary RACH configuration in this case. For example, a specific information element may be used for the secondary RACH configuration, and this information may be interpreted and processed by the xDD-aware UEs, but not by non-xDD-aware UEs. In the exemplary embodiments, the non-xDD-aware UEs may be the legacy UEs and/or new release UEs that do not have the xDD aware capability. Alternatively, the xDD-aware UEs may use both the primary and the secondary RACH configuration to determine the resources for RACH occasions. In other words, xDD-aware UEs may consider both RACH occasions that overlap with DL symbols as well as RACH occasions that overlap with UL symbols in both the primary and the secondary RACH configuration to be valid.

The non-xDD-aware UEs in the cell may use the other RACH configuration, for example the primary RACH configuration, to determine the resources for RACH occasions on UL symbols. In other words, the non-xDD-aware UEs may follow the Rel-15 or Rel-16 legacy rules, according to which only RACH occasions on UL symbols are considered as valid (i.e., the RACH occasions that overlap with DL symbols are not considered as valid by the legacy UEs).

For example, if the secondary RACH configuration is used by xDD-aware UEs, then the secondary RACH configuration may comprise more RACH occasions that overlap with DL symbols (DL-overlapping RACH occasions) compared to the primary RACH configuration. In other words, with two different configurations, the xDD-capable base station can intentionally configure more DL-overlapping RACH occasions in the secondary configuration, without introducing any impact on the legacy non-DL-overlapping RACH occasions. The RACH occasions in these two configurations may overlap with each other partially, or the RACH occasions configured by the secondary RACH configuration may include all RACH occasions configured by the first RACH configuration.

Alternatively, non-xDD-aware UEs may use the secondary RACH configuration, and xDD-aware UEs may use the primary RACH configuration.

As another alternative, the primary RACH configuration may be used by non-xDD-aware UEs, and xDD-aware UEs may use both the primary RACH configuration and the secondary RACH configuration. This allows the xDD-aware UEs to use the DL-overlapping RACH occasions in the primary configuration as well, without impacting the legacy UEs.

As another alternative, the primary RACH configuration may be used by both non-xDD-aware UEs (e.g., UEs in the next release(s) without having xDD-aware capability) and xDD-aware UEs, and the secondary RACH configuration may be used by both non-xDD-aware UEs and xDD-aware UEs. In this case, the secondary RACH configuration may enable the xDD-capable base station to configure more DL-overlapping RACH occasions without impacting the non-xDD-aware UEs on determining non-DL-overlapping RACH occasions.

At least one UE (for example an xDD-aware UE in the cell) implicitly determines 902 that the base station supports xDD, if two different RACH configurations are provided by the base station. The information on whether the base station supports xDD or not is used at the UE to determine the valid RACH occasions. The UE determines 903 which RACH occasions are valid to use for PRACH preamble transmission depending on the UE capability (i.e., depending on whether the UE is an xDD-aware UE or not). The UE may determine to use one or more RACH occasions that overlap with one or more DL symbols (i.e., one or more RACH occasions within a DL slot), if the UE is an xDD-aware UE, and if the base station indicates support for xDD. If the base station does not indicate support for xDD, then the xDD-aware UEs may follow the legacy UE behavior (i.e., the RACH occasions overlapping with DL symbols are determined as not valid in this case).

In this exemplary embodiment, an xDD mapping rule known at the UE may be used for determining the SSB-to-RACH-occasion mapping. The xDD mapping rule allows the UE to find RACH occasions that fall within DL slots and map these RACH occasions to SSB beams. The xDD mapping rule and the legacy mapping rule may coincide. The xDD mapping rule may be understood and applied by xDD-aware UEs, but not by legacy UEs (or non-xDD-aware UEs). The xDD mapping rule may be associated with the RACH occasions occurring on DL slots, over which xDD operations are performed by the base station. SSB-to-RACH-occasion mapping for UL slots may be performed according to the legacy mapping rule of Rel-15 or Rel-16. Herein a slot refers to a time slot.

The UE transmits 904, to the base station, a PRACH preamble on at least one of the determined RACH occasions that it considers as valid. The coverage condition at the UE may also be taken into account to efficiently utilize the determined RACH occasions. For example, for an xDD-aware UE with coverage shortage, the UE may transmit a PRACH preamble on one or more RACH occasions that do not overlap with DL symbols, as shown on the left side of FIG. 8. For an xDD-aware UE without coverage shortage, the UE may transmit the PRACH preamble on one or more RACH occasions that overlap with one or more DL symbols, according to the xDD mapping rule, as shown on the right side of FIG. 8. In this case, the xDD-aware UEs with coverage shortage may share the same pool of RACH occasions as the legacy UEs, and hence avoid using the RACH occasions that overlap with DL symbols, which may be impacted by in-device and cross-link interference.

The base station monitors 905 all RACH occasions in the configured PRACH slots, including the ones that overlap with DL symbols. The base station determines 906, or infers, the capability of the UE related to xDD based on the slot usage. For example, if the UE transmits the PRACH preamble on a RACH occasion that is within a DL slot, then the base station may determine that the UE is an xDD-aware UE, since legacy UEs are not capable of using RACH occasions overlapping with DL symbols. On the other hand, if the UE transmits the PRACH preamble on a RACH occasion that is within an UL slot, then the base station may determine that the UE is not an xDD-aware UE, and/or that the UE is in coverage shortage. The base station configures 907, or schedules, the UE with a Msg3 transmission over one or more UL slots and/or one or more DL slots operated in xDD mode based on the determined capability of the UE. The UE may transmit 908 the configured Msg3 transmission to the base station.

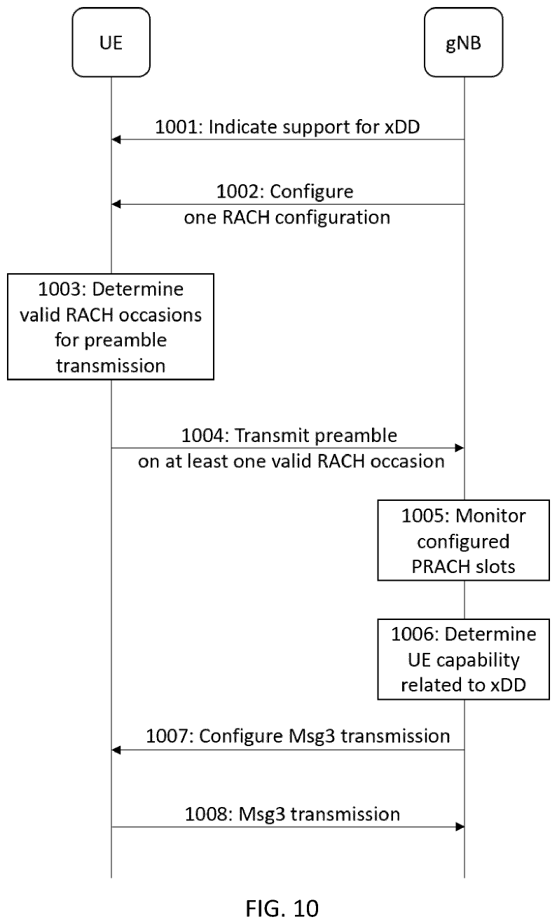

FIG. 10 illustrates a signaling diagram according to another exemplary embodiment, wherein a base station explicitly indicates that it supports xDD. Referring to FIG. 10, an xDD-capable base station indicates 1001, or broadcasts, to a plurality of UEs (for example, all UEs in the cell), that xDD operations are supported in the cell. This information may be broadcast, for example, via an MIB or SIB1 message. The indication may also comprise information on the SSB-to-RACH-occasion mapping rule (referred to as an xDD mapping rule herein) to be used by the UE(s). The base station configures 1002 one RACH configuration (i.e., one rach-config information element) for the plurality of UEs. In other words, a single common RACH configuration may be configured for all UEs in the cell.

The xDD-aware UEs may determine that the base station supports xDD by decoding the SSB in the MIB or SIB1 message, for example. The xDD-aware UEs in the cell may use the single RACH configuration to determine the radio resources for RACH occasions. If the base station indicates support for xDD operations, the xDD-aware UEs may consider both RACH occasions that overlap with DL symbols as well as RACH occasions that overlap with UL symbols to be valid. If the base station does not indicate support for xDD, then the xDD-aware UEs may follow the legacy UE behavior (i.e., the RACH occasions cannot overlap with DL symbols in this case).

The non-xDD aware UEs in the cell may also use the single RACH configuration to determine the radio resources for RACH occasions, and follow the Rel-15 or Rel-16 legacy rule, according to which only RACH occasions on UL symbols are considered as valid (i.e., the RACH occasions cannot overlap with DL symbols in the legacy UEs).

The information that the base station supports xDD is used by at least one UE (for example an xDD-aware UE in the cell) to determine the valid RACH occasions. The UE determines 1003 which RACH occasions are valid to use for PRACH preamble transmission depending on the UE capability (i.e., depending on whether the UE is an xDD-aware UE or not). The UE may determine to use one or more RACH occasions that overlap with one or more DL symbols, if the UE is an xDD-aware UE, and if the base station indicates support for xDD.

An xDD mapping rule known at the UE may be used for determining the SSB-to-RACH-occasion mapping. The xDD mapping rule and the legacy mapping rule may coincide. The xDD mapping rule may be understood and applied by xDD-aware UEs, but not by non-xDD-aware UEs. The xDD mapping rule may be associated with the RACH occasions occurring on DL slots, over which xDD operations are performed by the base station. SSB-to-RACH-occasion mapping for UL slots may be performed according to the legacy mapping rule of Rel-15 or Rel-16.

The UE transmits 1004, to the base station, a PRACH preamble on at least one of the determined RACH occasions that it considers as valid. The coverage condition at the UE may also be taken into account to efficiently utilize the determined RACH occasions. For example, for an xDD-aware UE with coverage shortage, the UE may transmit a PRACH preamble on one or more RACH occasions that overlap with one or more DL symbols, according to the xDD mapping rule. The DL symbols may refer to OFDM symbols. For an xDD-aware UE without coverage shortage, the UE may transmit the PRACH preamble on one or more RACH occasions that do not overlap with DL symbols. In this case, the xDD-aware UEs without coverage shortage may share the same pool of RACH occasions as the non-xDD-aware UEs. Furthermore, in this case, the base station knows that the UE is an xDD-aware UE and that the UE is in coverage shortage, when RACH occasions overlapping with DL symbols are used by the UE. In other words, the use of RACH occasions that overlap with DL symbols may be interpreted by the base station as a request from the UE for enabling coverage enhancement techniques in the next RACH message(s).

The base station monitors 1005 all RACH occasions in the configured PRACH slots, including the ones that overlap with DL symbols. The base station determines 1006, or infers, the capability of the UE related to xDD based on the slot usage. For example, if the UE transmits the PRACH preamble on a RACH occasion that is within a DL slot, then the base station may determine that the UE is an xDD-aware UE and/or that the UE is in coverage shortage, since non-xDD-aware UEs are not capable of using RACH occasions overlapping with DL symbols. On the other hand, if the UE transmits the PRACH preamble on a RACH occasion that is within an UL slot, then the base station may determine that the UE is not an xDD-aware UE, and/or that the UE is not in coverage shortage mode. The base station configures 1007, or schedules, the UE with a Msg3 transmission over one or more UL slots and/or one or more DL slots operated in xDD mode based on the determined capability of the UE. If the UE is determined to be in coverage shortage mode, then the base station may apply techniques to cope with the coverage shortage in the next RACH message(s). The UE may transmit 1008 the configured Msg3 transmission to the base station.

For example, back-to-back repetitions over UL and DL slots may be configured for the Msg3 transmission. Herein back-to-back repetitions mean Msg3 repetitions that occur in contiguous slots and without a gap. In a TDD framework such as DDDSU, a legacy UE would not be able to have back-to-back repetition, since the UL slots are spaced in time (i.e., there are no contiguous UL slots). xDD, however, offers this possibility since now the DL slots can also be used for UL transmissions, thus enabling back-to-back repetitions. For example, a lower latency may be achieved for the Msg3 transmission (and thus for the entire random-access procedure) for 4-step RACH (or MsgA PUSCH for 2 step-RACH) by configuring back-to-back repetitions over UL and DL slots.

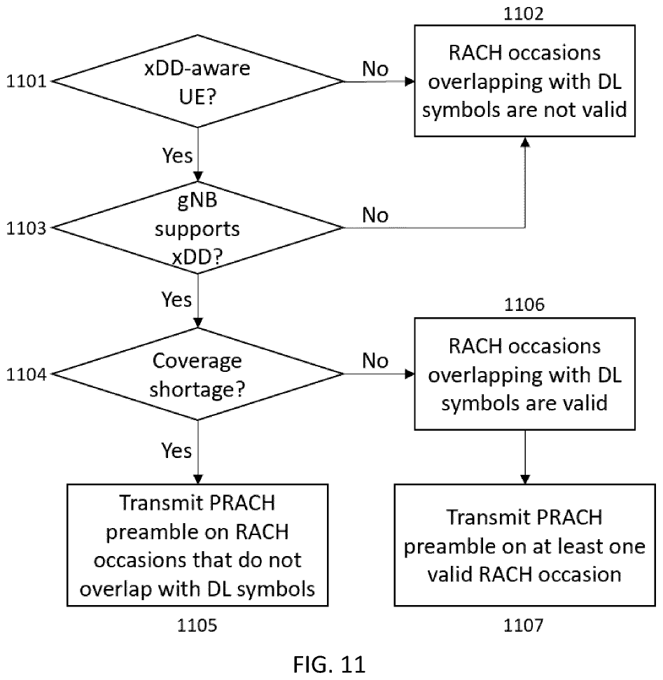

FIG. 11 illustrates a flow chart according to an exemplary embodiment for an algorithm for determining the RACH occasions to transmit the PRACH preamble on (e.g., step 903 of FIG. 9 or step 1003 of FIG. 10) UL and/or DL symbols. The functions illustrated in FIG. 11 may be performed by an apparatus such as, or comprised in, a terminal device (e.g., a UE).

Referring to FIG. 11, if the apparatus is not an xDD-aware UE (1101: no), then RACH occasions overlapping with DL symbols are determined 1102 to be invalid. In other words, the legacy rule, wherein only RACH occasions on UL symbols are considered as valid, is applied to determine valid RACH occasions and perform SSB-to-RACH-occasion mapping over them. If a primary RACH configuration and a secondary RACH configuration are configured, then the primary RACH configuration may be used in this case.

If the apparatus is an xDD-aware UE (1101: yes), but the base station does not indicate support for xDD (1103: no), then RACH occasions overlapping with DL symbols are determined 1102 to be invalid. In other words, the legacy rule, wherein only RACH occasions on UL symbols are considered as valid, is applied to determine valid RACH occasions and perform SSB-to-RACH-occasion mapping over them.

If the apparatus is an xDD-aware UE (1101: yes), and the base station indicates support for xDD (1103: yes), and the apparatus is in coverage shortage (1104: yes), then the apparatus may transmit 1105 a PRACH preamble on RACH occasions that do not overlap with DL symbols. The apparatus being in coverage shortage may also be referred to as a coverage shortage mode herein. For example, the RACH occasions that overlap with DL symbols may suffer from interference, and thus it may be beneficial to avoid using the RACH occasions that overlap with DL symbols, when the apparatus is in coverage shortage. If a primary RACH configuration and a secondary RACH configuration are configured, then the secondary RACH configuration or both of the RACH configurations may be used in this case. As a non-limiting example, the apparatus may determine whether it is in coverage shortage based on a threshold for reference signal received power (RSRP) and/or reference signal received quality (RSRQ), and/or based on link budget analysis based on signal-to-interference-plus-noise ratio (SINR). If RSRP and/or RSRQ is below the threshold, then the apparatus may determine that it is in coverage shortage, and enter the coverage shortage mode.

If the apparatus is an xDD-aware UE (1101: yes), and the base station indicates support for xDD (1103: yes), and the apparatus is not in coverage shortage (1104: no), then RACH occasions overlapping with DL symbols are determined 1106 to be valid, and an xDD mapping rule may be used to perform SSB-to-RACH-occasion mapping for the valid RACH occasions. The apparatus transmits 1107 a PRACH preamble on at least one valid RACH occasion that is mapped according to the xDD mapping rule. If a primary RACH configuration and a secondary RACH configuration are configured, then the secondary RACH configuration or both of the RACH configurations may be used in this case.

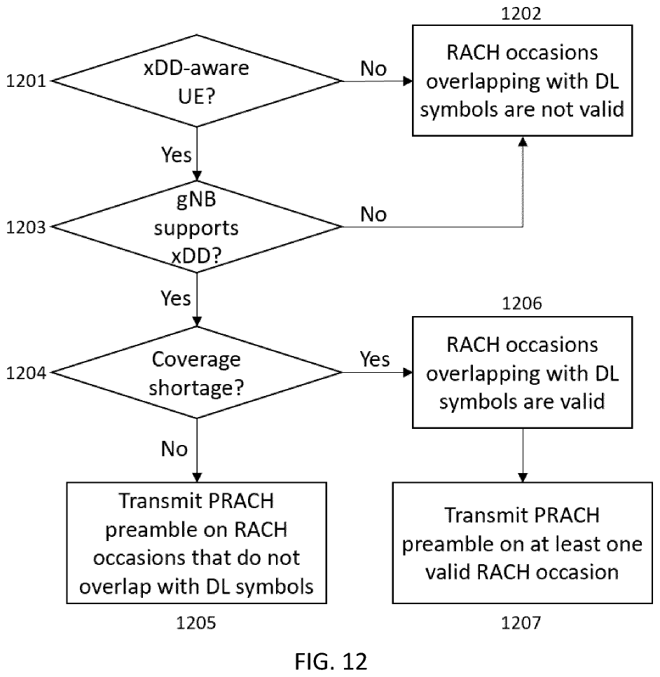

FIG. 12 illustrates a flow chart according to another exemplary embodiment for an algorithm for determining the RACH occasions to transmit the PRACH preamble on (e.g., step 903 of FIG. 9 or step 1003 of FIG. 10) UL and/or DL symbols. The functions illustrated in FIG. 12 may be performed by an apparatus such as, or comprised in, a terminal device (e.g., a UE).

Referring to FIG. 12, if the apparatus is not an xDD-aware UE (1201: no), then RACH occasions overlapping with DL symbols are determined 1202 to be invalid. In other words, the legacy rule, wherein only RACH occasions on UL symbols are considered as valid, is applied to determine valid RACH occasions and perform SSB-to-RACH-occasion mapping over them. If a primary RACH configuration and a secondary RACH configuration are configured, then the primary RACH configuration may be used in this case.

If the apparatus is an xDD-aware UE (1201: yes), but the base station does not indicate support for xDD (1203: no), then RACH occasions overlapping with DL symbols are determined 1202 to be invalid. In other words, the legacy rule, wherein only RACH occasions on UL symbols are considered as valid, is applied to determine valid RACH occasions and perform SSB-to-RACH-occasion mapping over them.

If the apparatus is an xDD-aware UE (1201: yes), and the base station indicates support for xDD (1203: yes), and the apparatus is not in coverage shortage (1204: no), then the apparatus may transmit 1205 a PRACH preamble on RACH occasions that do not overlap with DL symbols. If a primary RACH configuration and a secondary RACH configuration are configured, then the secondary RACH configuration or both of the RACH configurations may be used in this case.

If the apparatus is an xDD-aware UE (1201: yes), and the base station indicates support for xDD (1203: yes), and the apparatus is in coverage shortage (1204: yes), then RACH occasions overlapping with DL symbols are determined 1206 to be valid, and an xDD mapping rule may be used to perform SSB-to-RACH-occasion mapping for the valid RACH occasions. The apparatus transmits 1207 a PRACH preamble on at least one valid RACH occasion that is mapped according to the xDD mapping rule. If a primary RACH configuration and a secondary RACH configuration are configured, then the secondary RACH configuration or both of the RACH configurations may be used in this case.

In the exemplary embodiments, the xDD-aware UE may be referred to as a first UE, and the non-xDD-aware UE may be referred to as a second UE. In this case, the terms ‘first’ and ‘second’ are used to distinguish the UEs, and it does not mean a specific order of the UEs.

The xDD mapping rule may be applied for mapping SSB beams to RACH occasions occurring in uplink slots and to RACH occasions occurring in one or more downlink slots, wherein the one or more downlink slots are operated in xDD mode by the network. The xDD mapping rule may indicate that the RACH occasions occurring in the one or more downlink slots (operated in xDD mode by the network) are also valid, i.e., allowed to be used for transmitting the PRACH preamble.

As a first example of an xDD mapping rule, the same SSB beams used for the preceding one or more UL slots may be used for one or more DL slots operated in xDD.

As a second example of an xDD mapping rule, the xDD mapping rule may follow the same logic as the legacy rule, but considers all the RACH occasions occurring on UL slots and the RACH occasions occurring on DL slots operated in xDD for determining the SSB-to-RACH-occasion mapping for these slots. In other words, the RACH occasions occurring in DL slots and the RACH occasions occurring in UL slots may be mapped consecutively, such that the mapping of RACH occasions in each consecutive slot starts by continuing from the next SSB beam index compared to the last SSB beam index mapped to a RACH occasion in the preceding slot.

As a third example of an xDD mapping rule, the xDD mapping rule may follow the same logic as the legacy rule, but considers only the RACH occasions occurring on DL slots operated in xDD for determining the SSB-to-RACH-occasion mapping for these slots. In other words, the rule is applied for the RACH occasions in UL slots, and the same rule is applied for the RACH occasions occurring on DL slots, but they are performed independently, such that the RACH occasions occurring in DL slots are mapped to SSB beams independently from the RACH occasions occurring in UL slots.

As a fourth example of an xDD mapping rule, the xDD mapping rule may indicate to start from the index (or indices) of the last SSB beam (or beams) mapped to a RACH occasion in the preceding UL slot, and to apply an offset to the index of the last SSB beam, which depends on the RACH configuration, for example at least on ssb-perRACH-OccasionAndCB-PreamblesPerSSB in the RACH-ConfigCommon information element, and prach-ConfigurationIndex in the RACH-ConfigGeneric information element.

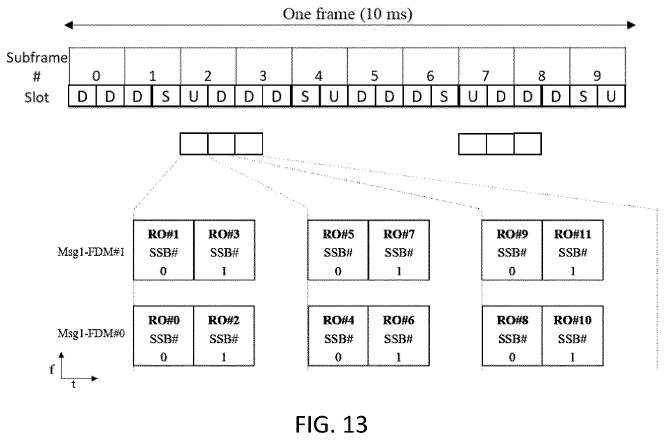

FIG. 13 illustrates another example of SSB-to-RACH occasion mapping according to an xDD mapping rule of an exemplary embodiment. FIG. 13 corresponds with the first example of the xDD mapping rule described above. In this example, it is assumed that the RACH occasions are configured with different RACH configurations (one with valid RACH occasions only in UL slot, one with valid RACH occasions in the next 2 DL slots, operated in xDD) with msg1-FDM=two, and ssb-perRACH-Occasion=oneHalf. The indexing of RACH occasions is from the perspective of xDD-aware UEs. In this exemplary embodiment, the same SSB beams used for the preceding one or more UL slots may be used for the DL slot(s) operated in xDD.

Referring to FIG. 13, RACH occasions #0 and #1 are mapped to SSB beam #0 in a UL slot of subframe #2, RACH occasions #2 and #3 are mapped to SSB beam #1 in the UL slot of subframe #2, RACH occasions #4 and #5 are mapped to SSB beam #0 in a DL slot of subframe #2, RACH occasions #6 and #7 are mapped to SSB beam #1 in the DL slot of subframe #2, RACH occasions #8 and #9 are mapped to SSB beam #0 in a DL slot of subframe #3, and RACH occasions #10 and #11 are mapped to SSB beam #1 in the DL slot of subframe #3. According to the xDD mapping rule, RACH occasions #0-11 are considered as valid. Otherwise, according to the legacy rule, RACH occasions #4-11 would not be considered as valid, since they are within a DL slot.

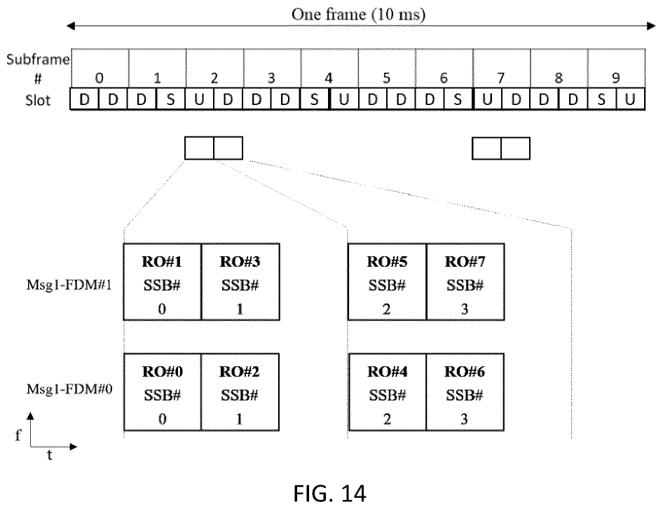

FIG. 14 illustrates an example of SSB-to-RACH occasion mapping according to an xDD mapping rule of an exemplary embodiment. FIG. 14 corresponds with the second example of the xDD mapping rule described above. In this example, it is assumed that all RACH occasions are configured by a single RACH configuration, or by different RACH configurations with the same parameters (msg1-FDM=two, and ssb-perRACH-Occasion=oneHalf). The indexing of RACH occasions is from the perspective of xDD-aware UEs. In this exemplary embodiment, the xDD mapping rule follows the same logic as the legacy rule, but considers all the RACH occasions occurring on UL slots, and the RACH occasions occurring on DL slots operated in xDD, for determining the SSB-to-RACH-occasion mapping for these slots. In other words, the mapping for the DL slot starts from the next SSB index (SSB beam #2) compared to the last SSB index (SSB beam #1) mapped to a RACH occasion in the preceding UL slot. The next SSB index (SSB beam #2) may be obtained, for example, by incrementing the last SSB index (SSB beam #1) in the preceding UL slot by one.

Referring to FIG. 14, subframe #2 has RACH occasions #0 and #1 mapped to SSB beam #0, RACH occasions #2 and #3 mapped to SSB beam #1, RACH occasions #4 and #5 mapped to SSB beam #2, and RACH occasions #6 and #7 mapped to SSB beam #3. RACH occasions #0, #1, #2, #3 are within an UL slot, and RACH occasions #4, #5, #6, and #7 are within a DL slot. According to the xDD mapping rule, RACH occasions #0, #1, #2, #3, #4, #5, #6 and #7 are considered as valid. Otherwise, according to the legacy rule, RACH occasions #4, #5, #6 and #7 would not be considered as valid, since they are within a DL slot.

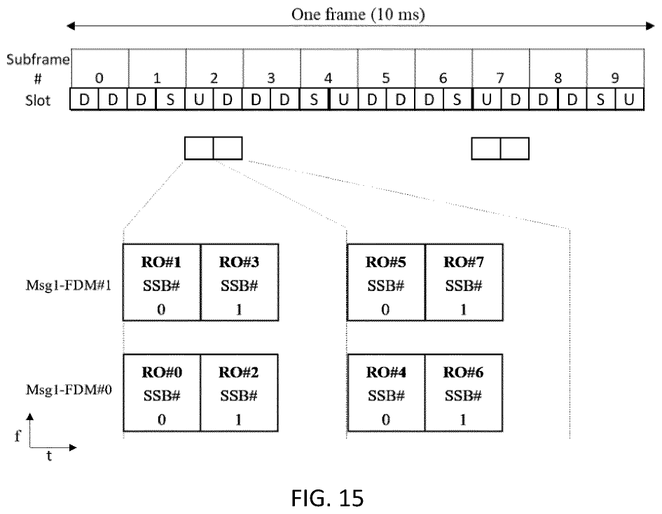

FIG. 15 illustrates another example of SSB-to-RACH occasion mapping according to an xDD mapping rule of an exemplary embodiment. FIG. 15 corresponds with the third example of the xDD mapping rule described above. In this example, it is assumed that all RACH occasions are configured by a single RACH configuration with the following parameters: msg1-FDM=two, and ssb-perRACH-Occasion=oneHalf. It should be noted that only one DL slot of every three DL slots is operated in xDD in this example. The indexing of RACH occasions is from the perspective of xDD-aware UEs. In this exemplary embodiment, the xDD mapping rule follows the same logic as the legacy rule, but considers only the RACH occasions occurring on DL slots operated in xDD for determining the SSB-to-RACH-occasion mapping for these slots. In other words, the rule is applied for the RACH occasions in UL slots, and the same rule is applied for the RACH occasions occurring on DL slots, but they are performed independently, such that the RACH occasions occurring in DL slots are mapped to SSB beams independently from the RACH occasions occurring in UL slots.

Referring to FIG. 15, subframe #2 has RACH occasions #0 and #1 mapped to SSB beam #0, RACH occasions #2 and #3 mapped to SSB beam #1, RACH occasions #4 and #5 mapped to SSB beam #0, and RACH occasions #6 and #7 mapped to SSB beam #1. RACH occasions #0, #1, #2, #3 are within an UL slot, and RACH occasions #4, #5, #6, and #7 are within a DL slot. According to the xDD mapping rule, RACH occasions #0, #1, #2, #3, #4, #5, #6 and #7 are considered as valid. Otherwise, according to the legacy rule, RACH occasions #4, #5, #6 and #7 would not be considered as valid, since they are within a DL slot. According to this xDD mapping rule, RACH occasions #4, #5, #6 and #7 are mapped independently from RACH occasions #0, #1, #2, #3. Therefore, mapping for RACH occasions #4 and #5 restart from SSB beam #0 again. In other words, the mapping of RACH occasions in the DL slot starts from the same SSB beam index (SSB beam #0) that is used to start mapping RACH occasions in the preceding UL slot.

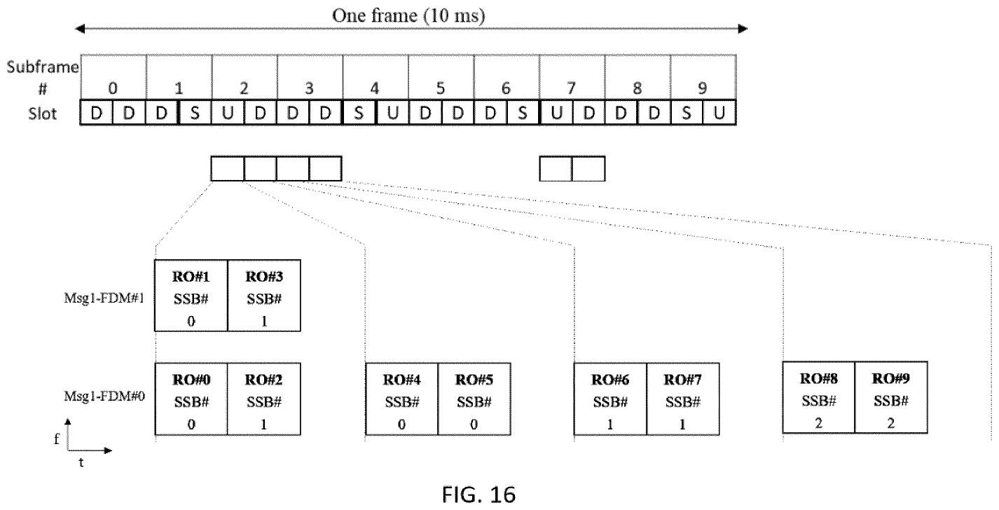

FIG. 16 illustrates another example of SSB-to-RACH occasion mapping according to an xDD mapping rule of an exemplary embodiment. FIG. 16 corresponds with the third example of the xDD mapping rule described above. In this example, there are two different RACH configurations: a primary RACH configuration and a secondary RACH configuration. The DL-overlapping RACH occasions may be configured by the secondary RACH configuration, for example. In the primary RACH configuration, msg1-FDM=two, and ssb-perRACH-Occasion=oneHalf. In the secondary RACH configuration, msg1-FDM=one, and ssb-perRACH-Occasion=oneHalf. The ssb-perRACH-Occasion may be configured commonly for both configurations in RACH-ConfigCommon. In this exemplary embodiment, the xDD mapping rule follows the same logic as the legacy rule, but considers only the RACH occasions occurring on DL slots operated in xDD for determining the SSB-to-RACH-occasion mapping for these slots.

Referring to FIG. 16, RACH occasions #0 and #1 are mapped to SSB beam #0 in a UL slot of subframe #2, RACH occasions #2 and #3 are mapped to SSB beam #1 in the UL slot of subframe #2, RACH occasions #4 and #5 are mapped to SSB beam #0 in a DL slot of subframe #2, RACH occasions #6 and #7 are mapped to SSB beam #1 in a first DL slot of subframe #3, and RACH occasions #8 and #9 are mapped to SSB beam #2 in a second DL slot of subframe #3. According to the xDD mapping rule, RACH occasions #0-9 are considered as valid. Otherwise, according to the legacy rule, RACH occasions #4-9 would not be considered as valid, since they are within a DL slot. According to this xDD mapping rule, RACH occasions #4, #5, #6, #7, #8 and #9 are mapped independently from RACH occasions #0, #1, #2, #3. Therefore, mapping for RACH occasions #4 and #5 restart from SSB beam #0 again.

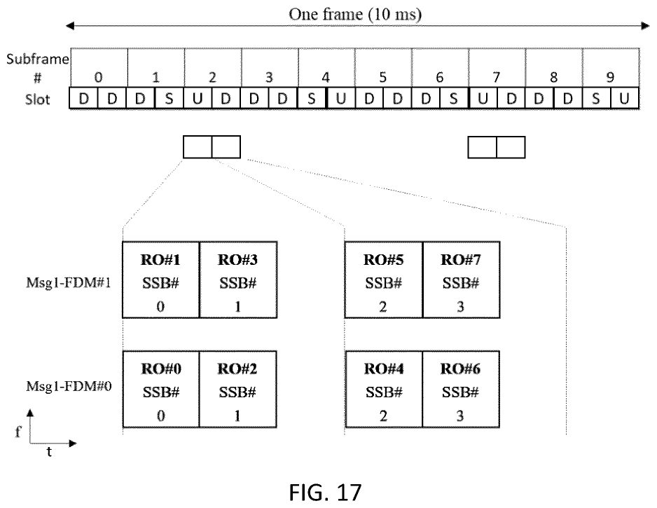

FIG. 17 illustrates another example of SSB-to-RACH occasion mapping according to an xDD mapping rule of an exemplary embodiment. FIG. 17 corresponds with the fourth example of the xDD mapping rule described above. In this example, it is assumed that all RACH occasions are configured by a single RACH configuration, or by different RACH configurations with the same parameters (msg1-FDM=two, and ssb-perRACH-Occasion=oneHalf). In this exemplary embodiment, the xDD mapping rule indicates to start from the index (or indices) of the last SSB beam (or beams) mapped to a RACH occasion in the preceding UL slot, and to apply an offset value of +1 to the index of the last SSB beam, which depends on the RACH configuration. In other words, the mapping starts from the index that has the offset applied to it.

Referring to FIG. 17, subframe #2 has RACH occasions #0 and #1 mapped to SSB beam #0, RACH occasions #2 and #3 mapped to SSB beam #1, RACH occasions #4 and #5 mapped to SSB beam #2, and RACH occasions #6 and #7 mapped to SSB beam #3. RACH occasions #0, #1, #2, #3 are within an UL slot, and RACH occasions #4, #5, #6, and #7 are within a DL slot. In other words, when mapping RACH occasions to SSB beams in the DL slot, an offset value of +1 is applied to the index of the last SSB beam (SSB #1) mapped to a RACH occasion in the preceding UL slot, and thus the mapping of RACH occasions in the DL slot starts from SSB beam #2 (1+1=2). According to the xDD mapping rule, RACH occasions #0, #1, #2, #3, #4, #5, #6 and #7 are considered as valid. Otherwise, according to the legacy rule, RACH occasions #4, #5, #6 and #7 would not be considered as valid, since they are within a DL slot.

As another example, if the offset value would be +2 in the example of FIG. 17, then the mapping of RACH occasions in the DL slot would start from SSB beam #3 (1+2=3) instead of SSB beam #2.

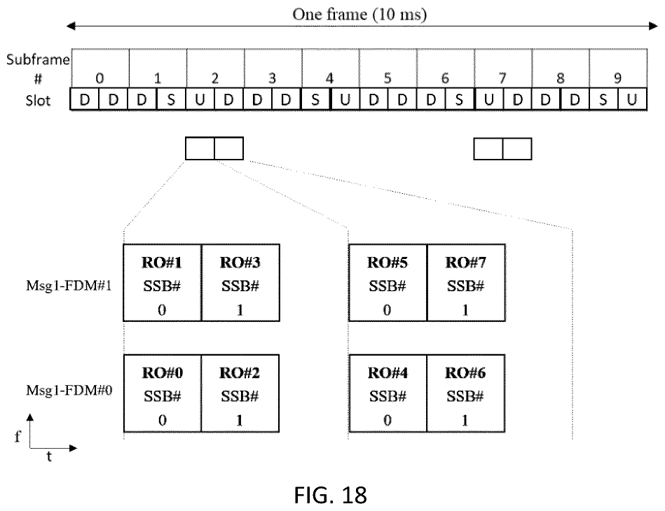

FIG. 18 illustrates another example of SSB-to-RACH occasion mapping according to an xDD mapping rule of an exemplary embodiment. FIG. 18 corresponds with the first example of the xDD mapping rule described above. In this example, it is assumed that all RACH occasions are configured by a single RACH configuration or by different RACH configurations with the same parameters (msg1-FDM=two, and ssb-perRACH-Occasion=oneHalf). It should be noted that only one DL slot of every three DL slots is operated in xDD in this example. In this exemplary embodiment, the xDD mapping rule indicates to start from the index (or indices) of the last SSB beam (or beams) mapped to a RACH occasion in the preceding UL slot, and to apply an offset value of −1 to the index of the last SSB beam, which depends on the RACH configuration. The network (e.g., an xDD-capable base station) may indicate the offset value to the xDD-aware UE, for example, via RRC (re) configuration or via dynamic indication in downlink control information (DCI).

Referring to FIG. 18, subframe #2 has RACH occasions #0 and #1 mapped to SSB beam #0, RACH occasions #2 and #3 mapped to SSB beam #1, RACH occasions #4 and #5 mapped to SSB beam #0, and RACH occasions #6 and #7 mapped to SSB beam #1. RACH occasions #0, #1, #2, #3 are within an UL slot, and RACH occasions #4, #5, #6, and #7 are within a DL slot. In other words, when mapping RACH occasions to SSB beams in the DL slot, an offset value of −1 is applied to the index of the last SSB beam (SSB #1) mapped to a RACH occasion in the preceding UL slot, and thus the mapping of RACH occasions in the DL slot starts from SSB beam #0 (1−1=0). According to the xDD mapping rule, RACH occasions #0, #1, #2, #3, #4, #5, #6 and #7 are considered as valid. Otherwise, according to the legacy rule, RACH occasions #4, #5, #6 and #7 would not be considered as valid, since they are within a DL slot. According to this xDD mapping rule, RACH occasions #4, #5, #6 and #7 are mapped to the same SSB beams as RACH occasions #0, #1, #2 and #3, respectively.

The xDD mapping rule may be known at the UE by means of at least one of the following three approaches.

In one approach, the xDD mapping rule may be pre-defined in the 3GPP specification followed by the UE.

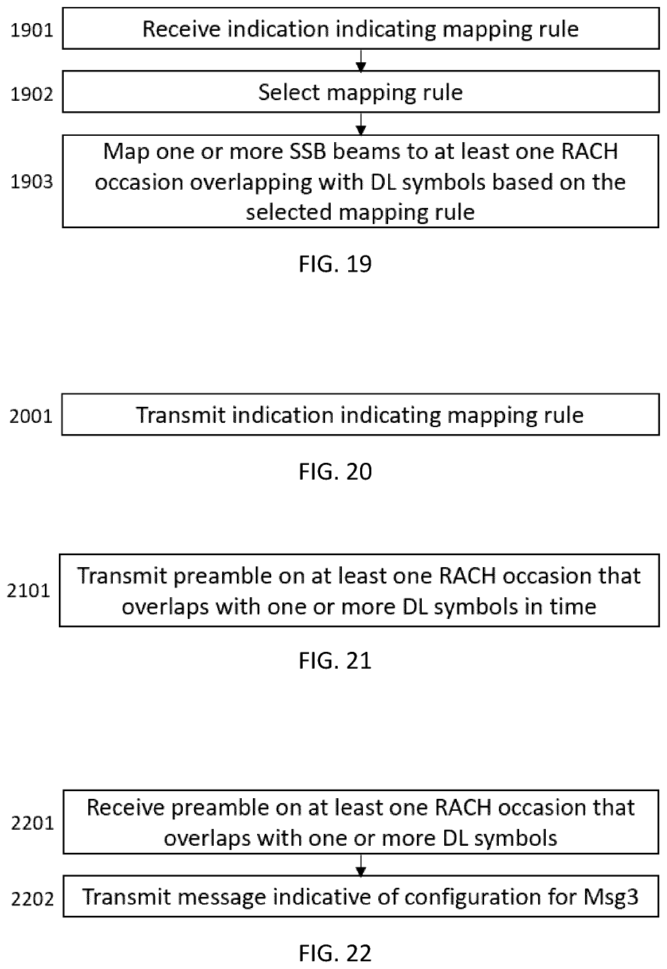

In another approach, a set of xDD mapping rules may be pre-defined in the 3GPP specification followed by the UE, and the base station may indicate, or broadcast, which rule from the set should be applied by the UE. The base station may broadcast the mapping rule to one or more UEs by using higher-layer signalling, such as SIB1 or remaining minimum system information (RMSI). FIG. 19 illustrates a flow chart according to an exemplary embodiment, wherein an indication indicating a mapping rule is received 1901 from a base station, and the mapping rule is selected 1902 from a set of pre-defined mapping rules based on the indication. One or more SSB beams are mapped 1903, or assigned, based on the selected mapping rule to at least one RACH occasion that overlaps with one or more DL symbols. The functions illustrated in FIG. 19 may be performed by an apparatus such as, or comprised in, a terminal device (e.g., an xDD-aware UE).

In another approach, there may be no pre-defined xDD mapping rules in the 3GPP specification followed by the UE, and the base station may broadcast the xDD mapping rule to be used by the UE. FIG. 20 illustrates a flow chart according to an exemplary embodiment, wherein an indication indicating a mapping rule is transmitted 2001, or broadcast, to one or more UEs. The mapping rule indicates to map one or more SSB beams to one or more RACH occasions overlapping with DL symbols. The functions illustrated in FIG. 20 may be performed by an apparatus such as, or comprised in, a base station. The base station may broadcast the mapping rule by using higher-layer signalling, such as SIB1 or RMSI. For example, the base station may signal one or more SSB beam indices to use to start the SSB-to-RACH-occasion mapping for DL slots operated in xDD mode. As another example, the base station may signal an offset to be applied to the index (or indices) of the last SSB beam (or beams) mapped to a RACH occasion in the preceding UL slot, in order to identify the one or more SSB beam indices to use to start the SSB-to-RACH-occasion mapping for DL slots operated in xDD.

FIG. 21 illustrates a flow chart according to an exemplary embodiment. The functions illustrated in FIG. 21 may be performed by an apparatus such as, or comprised in, a terminal device (e.g., an xDD-aware UE). Referring to FIG. 21, a random-access preamble (PRACH preamble) is transmitted 2101, to a network element (e.g., the gNB, the base station, etc.) of a wireless communication network, on at least one random-access channel occasion (RACH occasion) that overlaps with one or more downlink symbols in time, if cross-division duplexing is supported by the network element. The random-access preamble may be transmitted by using an SSB beam mapped to the at least one random-access channel occasion. The network element may be, for example, a network node, a base station, a gNB, or other network entity.

FIG. 22 illustrates a flow chart according to an exemplary embodiment. The functions illustrated in FIG. 22 may be performed by an apparatus such as, or comprised in, a network element (e.g., a base station) of a wireless communication network. Referring to FIG. 22, a random-access preamble is received 2201, from a terminal device, on at least one random-access channel occasion that overlaps, in time, with one or more downlink symbols associated with the terminal device. A message indicative of a configuration is transmitted 2202 to the terminal device in response to receiving the random-access preamble, wherein the configuration is for transmitting an RRC setup request message (i.e., Msg3) at least in one or more downlink slots operated in a cross-division duplexing mode supporting cross-division duplexing by the network element. The message transmitted to the terminal device may be, for example, a random-access response (i.e., Msg2).

The functions and/or blocks described above by means of FIGS. 9-12 and 19-22 are in no absolute chronological order, and some of them may be performed simultaneously or in an order differing from the described one. Other functions and/or blocks may also be executed between them or within them.

A technical advantage provided by some exemplary embodiments is that they may reduce collisions for both legacy UEs and xDD-aware UEs by offloading the xDD-aware UEs to a new resource pool not used by legacy UEs. In other words, the xDD-aware UEs may use RACH occasions that overlap with DL symbols, whereas the legacy UEs are limited to RACH occasions within UL slots. In addition, some exemplary embodiments may reduce the latency for the RACH procedure. Furthermore, some exemplary embodiments may increase the coverage for UEs, since Msg1 can be detected with a higher probability due to the reduced impact from collisions, and considering that Msg1 may already be suffering from coverage shortage. Moreover, some exemplary embodiments may provide increased capacity for the base station to handle RACH of all UEs in the cell. Usage of the RACH occasions overlapping with DL symbols can also be modelled as an implicit message that can be exploited by the base station to optimize RACH configuration, for example for Msg3 coverage enhancement in deployments with many xDD-aware UEs.

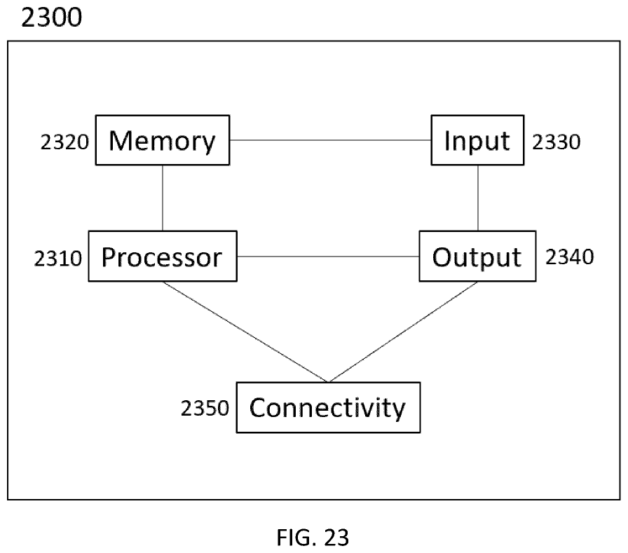

FIG. 23 illustrates an apparatus 2300, which may be an apparatus such as, or comprised in, a terminal device, according to an exemplary embodiment. A terminal device may also be referred to as a UE or user equipment herein. In addition, the terminal device may also be referred to as the xDD-aware UE or as the non-xDD-aware UE. In the above exemplary embodiments, the non-xDD-aware UE may be a legacy UE and/or a new release UE that do not have the xDD aware capability. The apparatus 2300 comprises a processor 2310. The processor 2310 interprets computer program instructions and processes data. The processor 2310 may comprise one or more programmable processors. The processor 2310 may comprise programmable hardware with embedded firmware and may, alternatively or additionally, comprise one or more application-specific integrated circuits (ASICs).

The processor 2310 is coupled to a memory 2320. The processor is configured to read and write data to and from the memory 2320. The memory 2320 may comprise one or more memory units. The memory units may be volatile or non-volatile. It is to be noted that in some exemplary embodiments there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The memory 2320 stores computer readable instructions that are executed by the processor 2310. For example, non-volatile memory stores the computer readable instructions and the processor 2310 executes the instructions using volatile memory for temporary storage of data and/or instructions.

The computer readable instructions may have been pre-stored to the memory 2320 or, alternatively or additionally, they may be received, by the apparatus, via an electromagnetic carrier signal and/or may be copied from a physical entity such as a computer program product. Execution of the computer readable instructions causes the apparatus 2300 to perform one or more of the functionalities described above.

In the context of this document, a “memory” or “computer-readable media” or “computer-readable medium” may be any non-transitory media or medium or means that can contain, store, communicate, propagate or transport the instructions for use by or in connection with an instruction execution system, apparatus, or device, such as a computer.

The apparatus 2300 may further comprise, or be connected to, an input unit 2330. The input unit 2330 may comprise one or more interfaces for receiving input. The one or more interfaces may comprise for example one or more temperature, motion and/or orientation sensors, one or more cameras, one or more accelerometers, one or more microphones, one or more buttons and/or one or more touch detection units. Further, the input unit 2330 may comprise an interface to which external devices may connect to.

The apparatus 2300 may also comprise an output unit 2340. The output unit may comprise or be connected to one or more displays capable of rendering visual content, such as a light emitting diode (LED) display, a liquid crystal display (LCD) and/or a liquid crystal on silicon (LCoS) display. The output unit 2340 may further comprise one or more audio outputs. The one or more audio outputs may be for example loudspeakers.

The apparatus 2300 further comprises a connectivity unit 2350. The connectivity unit 2350 enables wireless connectivity to one or more external devices. The connectivity unit 2350 comprises at least one transmitter and at least one receiver that may be integrated to the apparatus 2300 or that the apparatus 2300 may be connected to. The at least one transmitter comprises at least one transmission antenna, and the at least one receiver comprises at least one receiving antenna. The connectivity unit 2350 may comprise an integrated circuit or a set of integrated circuits that provide the wireless communication capability for the apparatus 2300. Alternatively, the wireless connectivity may be a hardwired application-specific integrated circuit (ASIC). The connectivity unit 2350 may comprise one or more components such as a power amplifier, digital front end (DFE), analog-to-digital converter (ADC), digital-to-analog converter (DAC), frequency converter, (de) modulator, and/or encoder/decoder circuitries, controlled by the corresponding controlling units.

It is to be noted that the apparatus 2300 may further comprise various components not illustrated in FIG. 23. The various components may be hardware components and/or software components.

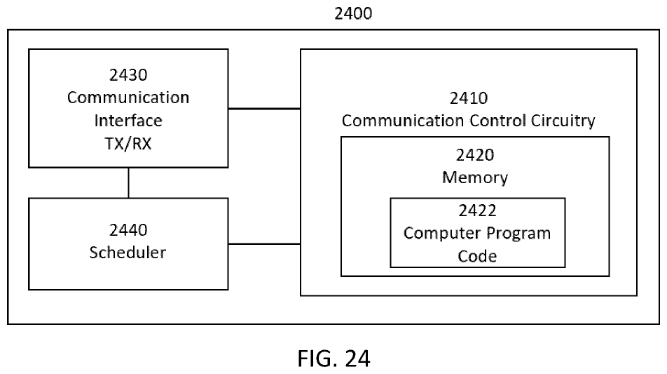

The apparatus 2400 of FIG. 24 illustrates an exemplary embodiment of an apparatus such as, or comprised in, a base station. The base station may be referred to, for example, as an xDD-capable base station, a network element, a network node, a RAN node, a NodeB, an LTE evolved NodeB (eNB), a gNB, an NR base station, a 5G base station, an access node, an access point (AP), a distributed unit (DU), a central unit (CU), a baseband unit (BBU), a radio unit (RU), a radio head, a remote radio head (RRH), or a transmission and reception point (TRP). The apparatus may comprise, for example, a circuitry or a chipset applicable to a base station for realizing some of the described exemplary embodiments. The apparatus 2400 may be an electronic device comprising one or more electronic circuitries. The apparatus 2400 may comprise a communication control circuitry 2410 such as at least one processor, and at least one memory 2420 including a computer program code (software) 2422 wherein the at least one memory and the computer program code (software) 2422 are configured, with the at least one processor, to cause the apparatus 2400 to carry out some of the exemplary embodiments described above.

The processor is coupled to the memory 2420. The processor is configured to read and write data to and from the memory 2420. The memory 2420 may comprise one or more memory units. The memory units may be volatile or non-volatile. It is to be noted that in some exemplary embodiments there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The memory 2420 stores computer readable instructions that are executed by the processor. For example, non-volatile memory stores the computer readable instructions and the processor executes the instructions using volatile memory for temporary storage of data and/or instructions.

The computer readable instructions may have been pre-stored to the memory 2420 or, alternatively or additionally, they may be received, by the apparatus, via an electromagnetic carrier signal and/or may be copied from a physical entity such as a computer program product. Execution of the computer readable instructions causes the apparatus 2400 to perform one or more of the functionalities described above.

The memory 2420 may be implemented using any suitable data storage technology, such as semiconductor-based memory devices, flash memory, magnetic memory devices and systems, optical memory devices and systems, fixed memory and/or removable memory. The memory may comprise a configuration database for storing configuration data. For example, the configuration database may store a current neighbour cell list, and, in some exemplary embodiments, structures of the frames used in the detected neighbour cells.

The apparatus 2400 may further comprise a communication interface 2430 comprising hardware and/or software for realizing communication connectivity according to one or more communication protocols. The communication interface 2430 comprises at least one transmitter (TX) and at least one receiver (RX) that may be integrated to the apparatus 2400 or that the apparatus 2400 may be connected to. The communication interface 2430 provides the apparatus with radio communication capabilities to communicate in the cellular communication system. The communication interface may, for example, provide a radio interface to terminal devices. The apparatus 2400 may further comprise another interface towards a core network such as the network coordinator apparatus and/or to the access nodes of the cellular communication system. The apparatus 2400 may further comprise a scheduler 2440 that is configured to allocate resources.

As used in this application, the term “circuitry” may refer to one or more or all of the following: a) hardware-only circuit implementations (such as implementations in only analog and/or digital circuitry); and b) combinations of hardware circuits and software, such as (as applicable): i) a combination of analog and/or digital hardware circuit(s) with software/firmware and ii) any portions of hardware processor(s) with software (including digital signal processor(s)), software, and memory(ies) that work together to cause an apparatus, such as a mobile phone, to perform various functions); and c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of exemplary embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, microcontrollers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The embodiments are not limited to the exemplary embodiments described above, but may vary within the scope of the claims. Therefore, all words and expressions should be interpreted broadly, and they are intended to illustrate, not to restrict, the exemplary embodiments.

1.-34. (canceled)

35. An apparatus comprising at least one processor, and at least one memory including computer program instructions, wherein the at least one memory and the computer program instructions are configured, with the at least one processor, to cause the apparatus to:
transmit, to a network element of a wireless communication network, if cross-division duplexing is supported by the network element, a random-access preamble on at least one random-access channel occasion that overlaps with one or more downlink symbols in time.

36. The apparatus according to claim 35, wherein the apparatus is further caused to:
receive, from the network element, an indication indicating that the cross-division duplexing is supported by the network element; and
determine that the cross-division duplexing is supported by the network element based at least partly on the indication indicating that the cross-division duplexing is supported by the network element.

37. The apparatus according to claim 35, wherein the apparatus is further caused to:
receive, from the network element, a message indicative of at least one random-access channel configuration for determining radio resources for random-access channel occasions; and
determine, based at least partly on the at least one random-access channel configuration, to use the at least one random-access channel occasion for transmitting the random-access preamble to the network element.

38. The apparatus according to claim 35, wherein the apparatus is further caused to:
receive a message indicative of at least two random-access channel configurations to be used for determining radio resources for random-access channel occasions.

39. The apparatus according to claim 38, wherein the at least two random-access channel configurations comprise a first random-access channel configuration and a second random-access channel configuration; and
wherein the second random-access channel configuration comprises more random-access channel occasions overlapping with downlink symbols compared to the first random-access channel configuration.

40. The apparatus according to claim 35, wherein the apparatus is further caused to:
determine, if the apparatus is in a coverage shortage mode, to use the at least one random-access channel occasion, which overlaps with the one or more downlink symbols in time, for transmitting the random-access preamble to the network element, or
determine, if the apparatus is not in a coverage shortage mode, to use the at least one random-access channel occasion, which overlaps with the one or more downlink symbols in time, for transmitting the random-access preamble to the network element.

41. The apparatus according to claim 35, wherein the apparatus is further caused to:
map at least one synchronization signal block beam to the at least one random-access channel occasion based on a mapping rule, wherein the mapping rule is applied for mapping synchronization signal block beams at least to one or more random-access channel occasions occurring in one or more downlink slots comprising the one or more downlink symbols, and wherein the mapping rule indicates that the one or more random-access channel occasions occurring in the one or more downlink slots are valid.

42. A method comprising:
transmitting, by a terminal device to a network element of a wireless communication network, if cross-division duplexing is supported by the network element, a random-access preamble on at least one random-access channel occasion that overlaps with one or more downlink symbols in time.

43. The method according to claim 42, further comprising:
receiving, by the terminal device from the network element, an indication indicating that the cross-division duplexing is supported by the network element; and
determining, by the terminal device, that the cross-division duplexing is supported by the network element based at least partly on the indication indicating that the cross-division duplexing is supported by the network element.

44. The method according to claim 42, further comprising:
receiving, by the terminal device from the network element, a message indicative of at least one random-access channel configuration for determining radio resources for random-access channel occasions; and
determining, by the terminal device based at least partly on the at least one random-access channel configuration, to use the at least one random-access channel occasion for transmitting the random-access preamble to the network element.

45. The method according to claim 42, further comprising:
receiving, by the terminal device, a message indicative of at least two random-access channel configurations to be used for determining radio resources for random-access channel occasions.

46. The method according to claim 45, wherein the at least two random-access channel configurations comprise a first random-access channel configuration and a second random-access channel configuration; and
wherein the second random-access channel configuration comprises more random-access channel occasions overlapping with downlink symbols compared to the first random-access channel configuration.

47. The method according to claim 42, further comprising:
determining, if the terminal device is in a coverage shortage mode, to use the at least one random-access channel occasion, which overlaps with the one or more downlink symbols in time, for transmitting the random-access preamble to the network element, or
determining, if the terminal device is not in a coverage shortage mode, to use the at least one random-access channel occasion, which overlaps with the one or more downlink symbols in time, for transmitting the random-access preamble to the network element.

48. The method according to claim 42, further comprising:
mapping at least one synchronization signal block beam to the at least one random-access channel occasion based on a mapping rule, wherein the mapping rule is applied for mapping synchronization signal block beams at least to one or more random-access channel occasions occurring in one or more downlink slots comprising the one or more downlink symbols, and wherein the mapping rule indicates that the one or more random-access channel occasions occurring in the one or more downlink slots are valid.

49. A non-transitory computer readable medium comprising instructions for causing a terminal device to perform at least the following:
transmitting, to a network element of a wireless communication network, if cross-division duplexing is supported by the network element, a random-access preamble on at least one random-access channel occasion that overlaps with one or more downlink symbols in time.

50. The non-transitory computer readable medium according to claim 49, further comprising instructions for causing the terminal device to perform at least following:
receiving, by the terminal device from the network element, an indication indicating that the cross-division duplexing is supported by the network element; and
determining, by the terminal device, that the cross-division duplexing is supported by the network element based at least partly on the indication indicating that the cross-division duplexing is supported by the network element.

51. The non-transitory computer readable medium according to claim 49, further comprising instructions for causing the terminal device to perform at least following:
receiving, from the network element, a message indicative of at least one random-access channel configuration for determining radio resources for random-access channel occasions; and
determining, based at least partly on the at least one random-access channel configuration, to use the at least one random-access channel occasion for transmitting the random-access preamble to the network element.

52. The non-transitory computer readable medium according to claim 49, further comprising instructions for causing the terminal device to perform at least following:
receiving a message indicative of at least two random-access channel configurations to be used for determining radio resources for random-access channel occasions.

53. The non-transitory computer readable medium according to claim 52,
wherein the at least two random-access channel configurations comprise a first random-access channel configuration and a second random-access channel configuration; and
wherein the second random-access channel configuration comprises more random-access channel occasions overlapping with downlink symbols compared to the first random-access channel configuration.

54. The non-transitory computer readable medium according to claim 49, further comprising instructions for causing the terminal device to perform at least following:
determining, if the terminal device is in a coverage shortage mode, to use the at least one random-access channel occasion, which overlaps with the one or more downlink symbols in time, for transmitting the random-access preamble to the network element, or
determining, if the terminal device is not in a coverage shortage mode, to use the at least one random-access channel occasion, which overlaps with the one or more downlink symbols in time, for transmitting the random-access preamble to the network element.
